(19) United States
(12) Patent Application Publication
(10) Pub. No.: US 2003/0076881 A1
(43) Pub. Date: Apr. 24, 2003

(54) Method and apparatus for coding and decoding image data

(76) Inventors: Kozo Akiyoshi, Tokyo (JP); Nobuo Akiyoshi, Tokyo (JP); Yoshihisa Shinagawa, Tokyo (JP)

Correspondence Address: Dowell & Dowell, P.C., Suite 309, 1215 Jefferson Davis Highway, Arlington, VA, 22202, US

(21) Appl. No.: 10/128,342

(22) Filed: Apr. 24, 2002

(30) Foreign Application Priority Data
Apr. 24, 2001 (JP) 2001-125579
May 22, 2001 (JP) 2001-152166

(51) Int. Cl. H04N 7/12

(52) U.S. Cl. 375/240.01; 348/700; 348/701

(57) ABSTRACT

An apparatus and method for coding and decoding image data in which image data are input, and the input data are separated into key frames and intermediate frames (which are frames other than the key frames). A pixel by pixel matching is then performed between the key frames to allow generation of both virtual key frames and intermediate frames between the key frames by interpolating the matching results. Actual frames, which may be key frames or intermediate frames, are then coded by determining a difference between virtual frames and actual frames, so that the actual frames can be coded based on the small amount of difference data.

### BACKGROUND OF THE INVENTION

1. Field of the Invention

The present invention relates to an image data processing technology, and more particularly relates to a method and apparatus for coding or decoding image data that contains a plurality of frames.

2. Description of the Related Art

Recently, image processing and compression methods such as those proposed by MPEG (Motion Picture Expert Group) have expanded to be used with transmission media such as network and broadcast rather than just storage media such as CDs. Generally speaking, the success of the digitization of broadcast materials has been caused at least in part by the availability of MPEG compression coding technology. In this way, a barrier that previously existed between broadcast and other types of communication has begun to disappear, leading to a diversification of service-providing businesses. Thus, we are facing a situation where it is hard to predict how the digital culture would evolve in this age of broadband.

Even in such a chaotic situation, it is clear that the direction of the compression technology of motion pictures will be to move to both higher compression rates and better image quality. It is a well-known fact that block distortion in MPEG compression is sometimes responsible for causing degraded image quality and preventing the compression rate from being improved.

### SUMMARY OF THE INVENTION

The present invention has been made in view of the foregoing circumstances and an object thereof is to provide a coding and decoding technique providing efficient compression of image data. Another object of the present invention is to provide an image coding and decoding technology that meets conflicting demands of improving the compression rate while retaining the image quality.

Image data processed in the present invention may be motion pictures or still pictures, including image data in which three-dimensional objects are visualized using two dimensional images, such as medical images or the like. That is, the image data may change along a time axis or a spatial axis. Moreover, it will be understood that other types of image data of arbitrary dimension can also be handled using similar processes.

A preferred embodiment according to the present invention relates to a method of coding image data. This method includes: a computing a primary matching between a first key frame and a second key frame included in the image data; generating a virtual third key frame based on a result of the primary matching; coding an actual third key frame included in the image data, by utilizing the virtual third key frame; and computing a secondary matching between adjacent key frames among the first, second and actual third key frames.

Here, a “key frame” indicates a reference frame on which a matching or other processes are to be performed, while an “intermediate frame” is a non-reference frame on which no matching processing is to be performed. In this patent specification, the term “frame” is, for the purpose of simplicity, used both to describe a unit of the image (unless otherwise indicated) and as the data itself, that is to be called “frame data”, constituting the unit.

Key frames, such as the third key frame described above, which are coded depending on other key frames are called “dependent key frames,” as occasion arises, whereas key frames other than the dependent key frames are called “independent key frames.” The dependent key frames may be coded by methods other than those according to the present embodiment. For example, an intra-frame compression coding such as JPEG 2000 may be performed. Similarly, the independent frames may also be coded by the method of the intra-frame compression coding.

Moreover, a third key frame may be coded by first and second key frames, and a fourth key frame may be coded by the second and third key frames and so forth, so that most of the key frames can serve as dependent key frames. In that case, a frame group may be generated in which dependence is closed within itself as in the GOP (Group Of Pictures) system of MPEG.

The “virtual third key frame” described above may be derived from a matching result, and the “actual third key frame” is a frame included in the original image data. The former is generated principally for the purpose of being similar to the latter, however the former will generally be at least somewhat different from the latter.

In this embodiment, the actual third key frame is processed in two directions, one of which is being coded by the primary matching and another of which is as an object for the secondary matching. After the primary matching, the actual third key frame can be coded based on the virtual third key frame generated. If a difference between the actual third key frame and the virtual key frame is substantially small (which is intended), the compression coding of this difference results in reduction of a coding amount for the actual third key frame. By performing this coding in a reversible manner, at least the third key frame can be restored completely. Next, if a result of the secondary matching is stored as corresponding point data, an intermediate frame between key frames (including the third key frame) can be generated by interpolation.

It is to be noted that, at the time of the secondary matching, a processing need not be repeated for a pair of key frames which have already been processed in the primary matching. Moreover, data other than data explicitly indicated as “to be coded” in the description may also be coded.

The primary matching may include computing, pixel by pixel, a matching between the first key frame and the second key frame, and the generating may generate the virtual third key frame by performing, pixel by pixel, an interpolation computation based on a correspondence relation of position and intensity of pixels between the first and second key frames.

The method may further include: outputting, as a coded data stream, the first and second key frames, the coded third key frame and corresponding point data obtained as a result of the secondary matching.

The coded third key frame may be generated in such a manner that the coded third key frame includes difference data of a difference between the virtual third key frame and the actual third key frame. This difference data may be entropy-coded, reversible-coded (i.e. losslessly-coded) or coded by other methods. The coded third key frame may be generated in such a manner that the coded third key frame further includes corresponding point data obtained as a result of the primary matching.

Another preferred embodiment according to the present invention also relates to a method of coding image data. In this method, the image frame data are separated into a key frame and an intermediate frame, and then coded. The method is characterized in that the intermediate frame is coded based on a result of, matching between key frames, and at least one of the key frames is also coded based on a result of matching between other key frames. In other words, at least one of the key frames is a dependent key frame, and the intermediate frame, which is coded by utilizing the dependent key frames too, receive a double-hierarchical coding processing, so to speak.

Still another preferred embodiment according to the present invention relates to an image data coding apparatus. This apparatus includes: a unit which acquires image data including a plurality of frames; a unit which computes a primary matching between first and second key frames included in the acquired image data; a unit which generates a virtual third key frame based on a result of the primary matching; a unit which codes an actual third key frame by utilizing the virtual third key frame; and a unit which computes a secondary matching between adjacent key frames among the first, second and actual third key frames.

Moreover, the first, second and third key frames may be arranged in this temporal order, and the generating unit may generate the virtual third key frame by extrapolation. Alternatively, the first, third and second key frames may be arranged in this temporal order, and the generating unit may generate the virtual third key frame by interpolation.

This apparatus may further include a unit which outputs the first and second key frames, the coded third key frame and data obtained as a result of the secondary matching, as a coded data stream.

The coded third key frame may be generated in such a manner that it includes difference data of a difference between the virtual third key frame and the actual third key frame. The coded third key frame may or may not include corresponding point data obtained as a result of the primary matching (hereinafter also referred to as “primary corresponding point data”). When included, a decoding side can easily reproduce the virtual third key frame based on the primary corresponding point data, and can decode the actual third key frame based on the reproduced virtual third key frame. When the primary corresponding point data are not included in the coded third key frame, it is preferred that the decoding side perform the primary matching by taking the same procedure as in the coding side and the virtual third key frame be first reproduced, with the following processing beng the same. When the computational load at the decoding side is taken into consideration, it is desirable that data including the primary corresponding point data be sent. The same concept applies to corresponding point data obtained as a result of the secondary matching (hereinafter also referred to as “secondary corresponding point data”).

Still another preferred embodiment according to the present invention relates to a method of decoding image data. This method-includes: acquiring a coded data stream which includes data of first and second key frames and data of a third key frame coded based on a result of a matching between the first and second key frames; decoding the third key frame from the acquired coded data stream; and computing a matching between adjacent key frames among the first, second and third key frames, and thereby generating an intermediate frame.

In still another preferred embodiment, there is provided a method which includes: acquiring a coded data stream which includes data of first and second key frames, data of a third key frame coded based on a result of a matching therebetween, and corresponding point data obtained as a result of computation of a matching between adjacent key frames among the first, second and third key frames; decoding the third key frame from the acquired coded data stream; and generating an intermediate frame based on the corresponding point data.

The coded third key frame data may include, for example, coded data of a difference between the virtual third key frame generated based on a result of the matching between the first and second key frames and the actual third key frame. In this case, a decoding step may be such that after the virtual third key frame is generated by computing the matching between the first and second key frames, the actual third key frame is decoded based on the thus generated virtual third key frame.

When the coded third key frame data include corresponding point data which is a result of a matching between the first and second key frames, and coded data of a difference between a virtual third key frame that is to be generated based on the corresponding point data and an actual third key frame, a decoding step may be such that after the virtual third key frame is generated based on the corresponding point data, the actual third key frame can be decoded based on the thus generated virtual third key frame.

Still another preferred embodiment according to the present invention relates to a method of coding image data. This method includes: separating key frames that are included in the image data into key frames and intermediate frames; generating a series of source hierarchical images of different resolutions by operating a multiresolutional critical point filter on a first key frame obtained by the separating; generating a series of destination hierarchical images of different resolutions by operating the multiresolutional critical point filter on a second key frame obtained by the separating; computing a matching of the source hierarchical images and the destination hierarchical images in a resolutional level hierarchy; generating a virtual third key frame based on a result of the matching; and coding an actual third key frame included in the image data, by utilizing the virtual third key frame.

Here, the term “separating” includes both the meaning of classifying those frames-initially unclassified into the key frames and the intermediate frames in a constructive sense, and classifying those initially classified in accordance with its indication in a sorting sense.

Still another preferred embodiment according to the present invention also relates to an image data coding apparatus. This apparatus includes: a functional block which acquires a virtual key frame generated based on a result of a matching performed between key frames included in image data; and a functional block which codes an actual key frame included in the image data, by utilizing the virtual key frame. This apparatus may further include a functional block which computes a matching between adjacent key frames including the actual key frame and which codes an intermediate frame that is other than the key frames.

Still another preferred embodiment according to the present invention relates to a method of decoding image data. This method includes: acquiring, from a coded data stream of the image data, first and second key frames and a third key frame which is coded based on a result of a processing performed between the first and second key frames and which is different from the first and second key frames; decoding the thus acquired coded third key frame; and generating an intermediate frame, which is not a key frame, by performing a processing between a plurality of key frames including the third key frame obtained as a result of the decoding.

It is to be noted that it is also possible to have replacement or substitution of the above-described structural components and elements of methods in part or whole as between method and apparatus or to add elements to either method or apparatus and also, the apparatuses and methods may be implemented by a computer program and saved on a recording medium or the like and are all effective as and encompassed by the present invention.

Moreover, this summary of the invention includes features that may not be necessary features such that an embodiment of the present invention may also be a sub-combination of these described features.

### BRIEF DESCRIPTION OF THE DRAWINGS

FIG. 1(a) is an image obtained as a result of the application of an averaging filter to a human facial image.

FIG. 1(b) is an image obtained as a result of the application of an averaging filter to another human facial image.

FIG. 1(c) is an image of a human face at p^{(5, 0)} obtained in a preferred embodiment in the base technology.

FIG. 1(d) is another image of a human face at p^{(5, 0)} obtained in a preferred embodiment in the base technology.

FIG. 1(e) is an image of a human face at p^{(5, 1)} obtained in a preferred embodiment in the base technology.

FIG. 1(f) is another image of a human face at p^{(5, 1)} obtained in a preferred embodiment in the base technology.

FIG. 1(g) is an image of a human face at p^{(5, 2)} obtained in a preferred embodiment in the base technology.

FIG. 1(h) is another image of a human face at p^{(5, 2)} obtained in a preferred embodiment in the base technology.

FIG. 1(i) is an image of a human face at p^{(5, 3)} obtained in a preferred embodiment in the base technology.

FIG. 1(j) is another image of a human face at p^{(5, 3)} obtained in a preferred embodiment in the base technology.

FIG. 2(R) shows an original quadrilateral.

FIG. 2(A) shows an inherited quadrilateral.

FIG. 2(B) shows an inherited quadrilateral.

FIG. 2(C) shows an inherited quadrilateral.

FIG. 2(D) shows an inherited quadrilateral.

FIG. 2(E) shows an inherited quadrilateral.

FIG. 3 is a diagram showing the relationship between a source image and a destination image and that between the m-th level and the (m−1)th level, using a quadrilateral.

FIG. 4 shows the relationship between a parameter η (represented by x-axis) and energy C_{f} (represented by y-axis)

FIG. 5(a) is a diagram illustrating determination of whether or not the mapping for a certain point satisfies the bijectivity condition through the outer product computation.

FIG. 5(b) is a diagram illustrating determination of whether or not the mapping for a certain point satisfies the bijectivity condition through the outer product computation.

FIG. 6 is a flowchart of the entire procedure of a preferred embodiment-in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source hierarchical images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 12.

FIG. 16 is a graph showing the behavior of energy C_{f}^{(m,s)} corresponding to f^{(m, s)} (λ=iΔλ) which has been obtained for a certain f^{(m, s)} while varying λ.

FIG. 17 is a diagram showing the behavior of energy C_{f}⁽ⁿ⁾ corresponding to f⁽ⁿ⁾ (η=iΔη)(i=0, 1, . . . ) which has been obtained while varying η.

FIG. 18 is a conceptual diagram showing image data coding.

FIG. 19 shows an image data coding apparatus.

FIG. 20 is a flowchart showing processes carried out by the image data coding apparatus of FIG. 19.

FIG. 21 shows a structure of coded image data.

FIG. 22 shows an image data decoding apparatus.

FIG. 23 is a flowchart showing processes carried out by the image data decoding apparatus of FIG. 22.

FIG. 24 is a conceptual diagram showing a process in which image data are coded according to an extended technology of an embodiment of the invention.

FIG. 25 shows an image data coding apparatus according to the extended technology shown in FIG. 24.

FIG. 26 is a conceptual diagram showing image data coding in which dependent key frames and intermediate frames are coded by utilizing actual key frames, according to the extended technology of the present embodiment.

FIG. 27 is a flowchart showing processes carried out by the image data coding apparatus of FIG. 25.

FIG. 28 is a structure of coded image data according to the extended technology of the present embodiment.

FIG. 29 is an image data decoding apparatus according to the extended technology of the present embodiment.

FIG. 30 is a flowchart showing processes carried out by the image data decoding apparatus of FIG. 29.

### DETAILED DESCRIPTION OF THE INVENTION

The invention will now be described based on the preferred embodiments, which are not intended to limit the scope of the present invention, but exemplify the invention. All of the features and the combinations thereof described in an embodiment are not necessarily essential to the invention.

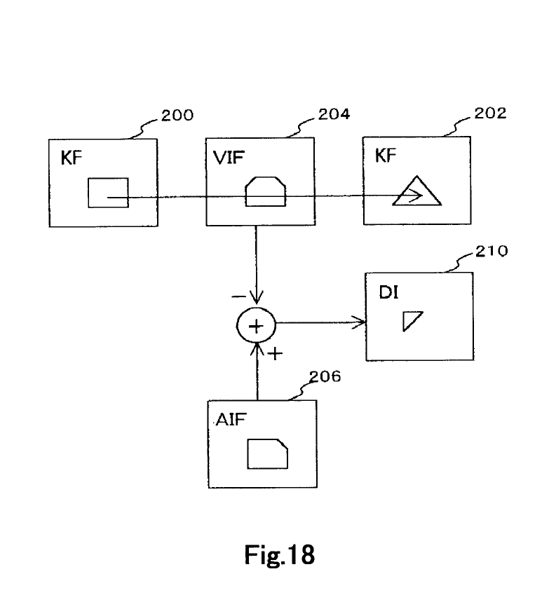

First, the multiresolutional critical point filter technology and the image matching processing using the technology, both of which will be utilized in the preferred embodiments, will be described in detail as “Base Technology”. Namely, the following sections [1] and [2] (below) belong to the base technology, where section [1] describes elemental techniques and section [2] describes a processing procedure. These techniques are patented under Japanese Patent No. 2927350 and owned by the same assignee of the present invention. However, it is to be noted that the image matching techniques provided in the present embodiments are not limited to the same levels. In particular, in FIGS. 18 to 30, image data coding and decoding techniques, utilizing, in part, the base technology, will be described in more detail.

Base Technology

[1] Detailed Description of Elemental Techniques

[1.1] Introduction

Using a set of new multiresolutional filters called critical point filters, image matching is accurately computed. There is no need for any prior knowledge concerning the content of the images or objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, There is no need to manually specify the correspondence of points between the images.

The base technology can be applied to, for instance, completely automated morphing, object recognition, stereo photogrammetry, volume rendering, and smooth generation of motion images from a small number of frames. When applied to morphing, given images can be automatically transformed. When applied to volume rendering, intermediate images between cross sections can be accurately reconstructed, even when a distance between cross sections is rather large and the cross sections vary widely in shape.

[1.2] The Hierarchy of the Critical Point Filters The multiresolutional filters according to the base technology preserve the intensity and location of each critical point included in the images while reducing the resolution. Initially, let the width of an image to be examined be N and the height of the image be M. For simplicity, assume that N=M=2n where n is a positive integer. An interval [0, N] ⊂ R is denoted by I. A pixel of the image at position (i, j) is denoted by p^{(i, j)} where i,j ε I.

Here, a multiresolutional hierarchy is introduced. Hierarchized image groups are produced by a multiresolutional filter. The multiresolutional filter carries out a two dimensional search on an original image and detects critical points therefrom. The multiresolutinal filter then extracts the critical points from the original image to construct another image having a lower resolution. Here, the size of each of the respective images of the m-th level is denoted as 2^{m}×2^{m} (0≦m≦n). A critical point filter constructs the following four, new hierarchical images recursively, in the direction descending from n.

p_{(i,j)}^{(m,0)}=min(min(p_{(2i,2j)}^{(m+1,0)}, p_{(2i,2j+1)}^{(m+1,0)}),

min(p_{(2i+1,2j)}^{(m+1,0)}, p_{(2i+1,2j+1)}^{(m+1,0)})) p_{(i,j)}^{(m,1)}=max(min(p_{(2i,2j)}^{(m+1,1)}, p_{(2i,2j+1)}^{(m+1,1)}), min(p_{(2i+1,2j)}^{(m+1,1)}, p_{(2i+1,2j+1)}^{(m+1,1)})) p_{(i,j)}^{(m,2)}=min(max(p_{(2i,2j)}^{(m+1,2)}, p_{(2i,2j+1)}^{(m+1,2)}), max(p_{(2i+1,2j)}^{(m+1,2)}, p_{(2i+1,2j+1)}^{(m+1,2)})) p_{(i,j)}^{(m,3)}=max(max(p_{(2i,2j)}^{(m+1,3)}, p_{(2i,2j+1)}^{(m+1,3)}), max(p_{(2i+1,2j)}^{(m+1,3)}, p_{(2i+1,2j+1)}^{(m+1,3)})) (1)

where we let

p_{(i,j)}^{(n,0)}=p_{(i,j)}^{(n,1)}=p_{(i,j)}^{(n,2)}=p_{(i,j)}^{(n,3)}=p_{(i,j)} (2)

The above four images are referred to as subimages hereinafter. When min_{x≦t≦x+1} and max_{x≦t≦x+1} are abbreviated to α and β respectively, the subimages can be expressed as follows:

P^{(m,0)}=α(x)α(y)p^{(m+1,0)}

P^{(m,1)}=α(x)β(y)p^{(m+1,1)}

P^{(m,2)}=β(x)α(y)p^{(m+1,2)}

P^{(m,2)}=β(x)β(y)p^{(m+1,3)}

Namely, they can be considered analogous to the tensor products of α and β. The subimages correspond to the respective critical points. As is apparent from the above equations, the critical point filter detects a critical point of the original image for every block consisting of 2×2 pixels. In this detection, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are detected as a local maximum point, a local minimum point, and a saddle point, respectively.

By using the critical point filter, an image (1 pixel here) of a critical point detected inside each of the respective blocks serves to represent its block image (4 pixels here) in the next lower resolution level. Thus, the resolution of the image is reduced. From a singularity theoretical point of view, α (x) α (y) preserves the local minimum point (minima point), β (x) β (y) preserves the local maximum point (maxima point), α (x) β (y) and β (x) α (y) preserve the saddle points.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of resolution levels. First, the minima points are matched using p^{(m, 0)} Next, the first saddle points are matched using p^{(m, 1)} based on the previous matching result for the minima points. The second saddle points are matched using p^{(m, 2)}. Finally, the maxima points are matched using p^{(m, 3)}.

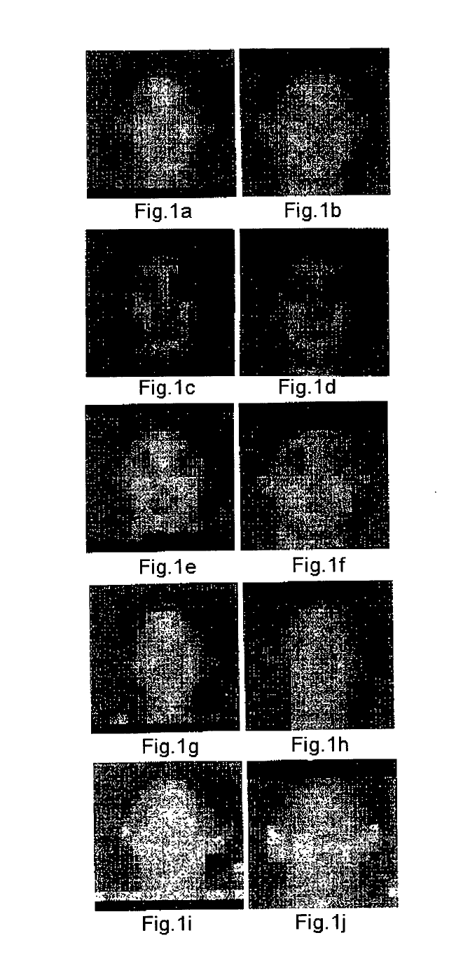

FIGS. 1c and 1d show the subimages p^{(5, 0)} of the images in FIGS. 1a and 1b, respectively. Similarly, FIGS. 1e and 1f show the subimages p^{(5, 1)}, FIGS. 1g and 1h show the subimages p^{(5, 2)}, and FIGS. 1i and 1j show the subimages p^{(5, 3)}. Characteristic parts in the images can be easily matched using subimages. The eyes can be matched by p^{(5, 0)} since the eyes are the minima points of pixel intensity in a face. The mouths can be matched by p^{(5, 1)} since the mouths have low intensity in the horizontal direction. Vertical lines on both sides of the necks become clear by p^{(5, 2)}. The ears and bright parts of the cheeks become clear by p^{(5, 3)} since these are the maxima points of pixel intensity.

As described above, the characteristics of an image can be extracted by the critical point filter. Thus, by comparing, for example, the characteristics of an image shot by a camera with the characteristics of several objects recorded in advance, an object shot by the camera can be identified.

[1.3] Computation of Mapping Between Images

Now, for matching images, a pixel of the source image at the location (i, j) is denoted by p_{(i,j)}⁽ⁿ⁾ and that of the destination image at (k, l) is denoted by q_{(k,l)}⁽ⁿ⁾ where i, j, k, l ε I. The energy of the mapping between the images (described later in more detail) is then defined. This energy is determined by the difference in the intensity of the pixel of the source image and its corresponding pixel of the destination image and the smoothness of the mapping. First, the mapping f^{(m, 0)}:p^{(m,0)}→q^{(m, 0)} between p^{(m, 0)} and q^{(m, 0)} with the minimum energy is computed. Based on f^{(m, 0)}, the mapping f^{(m, 1)} between p^{(m, 1)} and q^{(m, 1)} with the minimum energy is computed. This process continues until f^{(m, 3)} between p^{(m, 3)} and q^{(m, 3)} is computed. Each f^{(m, i) (i=}0, 1, 2, . . . ) is referred to as a submapping. The order of i will be rearranged as shown in the following equation (3) in computing f^{(m, 1)} for reasons to be described later.

f^{(m,i)}:p^{(m,σ(i))}→q^{(m,σ(i))} (3)

where σ (i) ε {0, 1, 2, 3}.

[1. 3. 1] Bijectivity

When the matching between a source image and a destination image is expressed by means of a mapping, that mapping shall satisfy the Bijectivity Conditions (BC) between the two images (note that a one-to-one surjective mapping is called a bijection). This is because the respective images should be connected satisfying both surjection and injection, and there is no conceptual supremacy existing between these images. It is to be noted that the mappings to be constructed here are the digital version of the bijection. In the base technology, a pixel is specified by a co-ordinate point.

The mapping of the source subimage (a subimage of a source image) to the destination subimage (a subimage of a destination image) is represented by f^{(m, s):I/}2^{n-m}×I/2^{n-m}→I/2^{n-m}×I/2^{n-m} (s=0, 1, . . . ), where f_{(i,j)}^{(m,s)}=(k,l) means that p_{(i,j)}^{(m,s)} of the source image is mapped to q_{(k,l)}^{(m,s)} of the destination image. For simplicity, when f(i, j)=(k, l) holds, a pixel q_{(k, l)} is denoted by q_{f(i, j)}.

When the data sets are discrete as image pixels (grid points) treated in the base technology, the definition of bijectivity is important. Here, the bijection will be defined in the following manner, where i, j, k and l are all integers. First, a square region R defined on the source image plane is considered

p_{(i,j)}^{(m,s)}p_{(i+1,j)}^{(m,s)}p_{(i+1,j+1)}^{(m,s)}p_{(i,j+1)}^{(m,s)} (4)

where i=0, . . . , 2^{m}−1, and j=0, . . . , 2^{m}−1. The edges of R are directed as follows:

\overline{p_{(i,j)}^{(m,s)}p_{(i+1,j)}^{(m,s)}}, \overline{p_{(i+1,j)}^{(m,s)}p_{(i+1,j+1)}^{(m,s)}}, \overline{p_{(i+1,j+1)}^{(m,s)}p_{(i,j+1)}^{(m,s)}} and \overline{p_{(i,j+1)}^{(m,s)}p_{(i,j)}^{(m,s)}} (5)

This square region R will be mapped by f to a quadrilateral on the destination image plane:

q_{f(i,j)}^{(m,s)}q_{f(i+1,j)}^{(m,s)}q_{f(i+1,j+1)}^{(m,s)}q_{f(i,j+1)}^{(m,s)} (6)

This mapping f^{(m, s)} (R), that is,

f^{(m,s)} (R)=f^{(m,s)}(p_{(i,j)}^{(m,s)}p_{(i+1,j)}^{(m,s)}p_{(i+1,j+1)}^{(m,s)}p_{(i,j+1)}^{(m,s)}=q_{f(i,j)}^{(m,s)}q_{f(i+1,j)}^{(m,s)}q_{f(i+1,j+1)}^{(m,s)}q_{f(i,j+1)}^{(m,s)})

should satisfy the following bijectivity conditions(referred to as BC hereinafter):

1. The edges of the quadrilateral f^{(m, s)} (R) should not intersect one another.

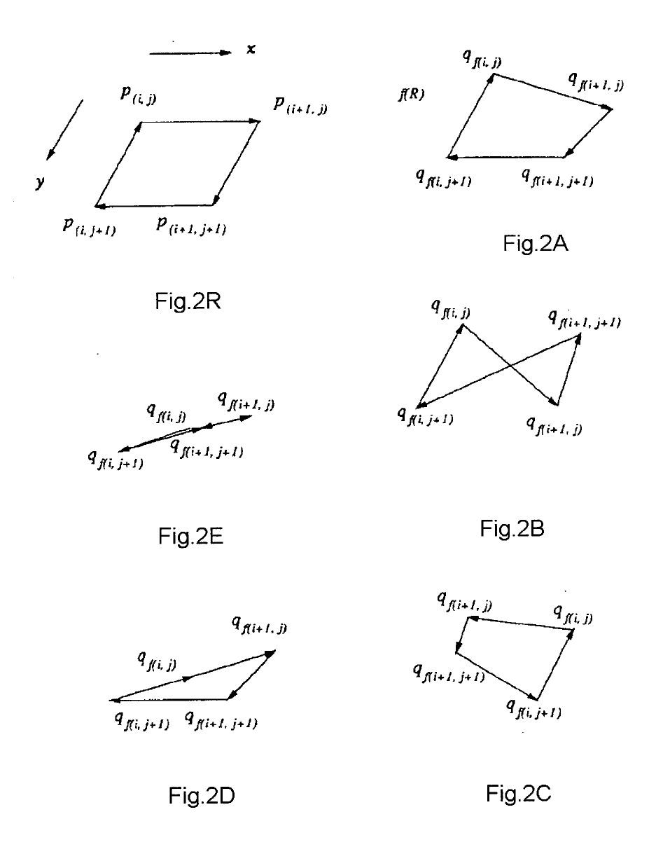

2. The orientation of the edges of f^{(m, s)} (R) should be the same as that of R (clockwise in the case shown in FIG. 2, described below).

3. As a relaxed condition, a retraction mapping is allowed.

Without a certain type of a relaxed condition as in, for example, condition 3 above, there would be no mappings which completely satisfy the BC other than a trivial identity mapping. Here, the length of a single edge of f^{(m, s)} (R) may be zero. Namely, f^{(m, s)} (R) may be a triangle. However, f^{(m, s)} (R) is not allowed to be a point or a line segment having area zero. Specifically speaking, if FIG. 2R is the original quadrilateral, FIGS. 2A and 2D satisfy the BC while FIGS. 2B, 2C and 2E do not satisfy the BC.

In actual implementation, the following condition may be further imposed to easily guarantee that the mapping is surjective. Namely, each pixel on the boundary of the source image is mapped to the pixel that occupies the same location at the destination image. In other words, f(i, j)=(i, j) (on the four lines of i=0, i=2^{m}−1, j=0, j=2^{m}−1). This condition will be hereinafter referred to as an additional condition.

[1. 3. 2] Energy of Mapping

[1. 3. 2. 1] Cost Related to the Pixel Intensity

The energy of the mapping f is defined. An objective here is to search a mapping whose energy becomes minimum. The energy is determined mainly by the difference in the intensity between the pixel of the source image and its corresponding pixel of the destination image. Namely, the energy C_{(i,j)}^{(m,s)} of the mapping f^{(m, s)} at (i, j) is determined by the following equation (7).

$${C}_{( i , j )}^{( m , s )} = {\vert V ( {p}_{( i , j )}^{( m , s )} ) - V ( {q}_{f ( i , j )}^{( m , s )} ) \vert}^{2} \qquad ( 7 )$$

where V(p_{(i,j)}^{(m,s)}) and V(q_{f(i,j)}^{(m,s)}) are the intensity values of the pixels p_{(i,j)}^{(m,s)} and q_{f(i,j)}^{(m,s)}, respectively. The total energy C^{(m, s)} of f is a matching evaluation equation, and can be defined as the sum of C_{(i,j)}^{(m,s)} as shown in the following equation (8).

$${C}_{f}^{( m , s )} = {\sum }_{i = 0}^{i = {2}^{m} - 1} {\sum }_{j = 0}^{j = {2}^{m} - 1} {C}_{( i , j )}^{( m , s )} \qquad ( 8 )$$

[1. 3. 2. 2] Cost Related to the Locations of the Pixel for Smooth Mapping

In order to obtain smooth mappings, another energy D_{f} for the mapping is introduced. The energy D_{f} is determined by the locations of p_{(i,j)}^{(m,s)} and q_{(i,j)}^{(m,s)} (i=0, 1, . . . , 2^{m}−1, j=0, 1, . . . , 2^{m}−1), regardless of the intensity of the pixels. The energy D_{(i,j)}^{(m,s)} of the mapping f^{(m, s)} at a point (i,j) is determined by the following equation (9).

D_{(i,j)}^{(m,s)}=ηE_{0(i,j)}^{(m,s)}+E_{1(i,j)}^{(m,s)} (9)

where the coefficient parameter η which is equal to or greater than 0 is a real number. And we have

E_{0(i,j)}^{(m,s)}=∥(i, j)−f^{(m,s)}(i, j)∥² (10)

$$\begin{matrix}{E}_{1 ( i , j )}^{( m , s )} = {\sum }_{{i}^{′} = i - 1}^{i} {\sum }_{{j}^{′} = j - 1}^{j} \\ {‖ ( {f}^{( m , s )} ( i , j ) - ( i , j ) ) - ( {f}^{( m , s )} ( {i}^{′} , {j}^{′} ) - ( {i}^{′} , {j}^{′} ) ) ‖}^{2} / 4\end{matrix} \qquad ( 11 )$$

where

∥(x, y)∥=\sqrt{x²+y²} (12),

i′ and j′ are integers and f(i′,j′) is defined to be zero for i′<0 and j′<0. E₀ is determined by the distance between (i,j) and f(i,j). E₀ prevents a pixel from being mapped to a pixel too far away from it. However, as explained below, E₀ can be replaced by another energy function. E₁ ensures the smoothness of the mapping. E₁ represents a distance between the displacement of p(i, j) and the displacement of its neighboring points. Based on the above consideration, another evaluation equation for evaluating the matching, or the energy D_{f} is determined by the following equation:

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} \qquad ( 13 )$$

[1. 3. 2. 3] Total Energy of the Mapping

The total energy of the mapping, that is, a combined evaluation equation which relates to the combination of a plurality of evaluations, is defined as λC_{f}^{(m,s)}+D_{f}^{(m,s)}, where λ≧0 is a real number. The goal is to detect a state in which the combined evaluation equation has an extreme value, namely, to find a mapping which gives the minimum energy expressed by the following:

$${min}_{f} \{ λ {C}_{f}^{( m , s )} + {D}_{f}^{( m , s )} \} \qquad ( 14 )$$

Care must be exercised in that the mapping becomes an identity mapping if λ=0 and η=0 (i.e., f^{(m, s)} (i, j)=(i, j) for all i=0, 1, . . . , 2^{m}−1 and j=0, 1, . . . , 2^{m}−1). As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η=0 will be C_{f}^{(m,s)} only. As a result thereof, pixels would randomly matched to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, differences in the pixel intensity and smoothness are considered in a technique called “optical flow” that is known in the art. However, the optical flow technique cannot be used for image transformation since the optical flow technique takes into account only the local movement of an object. However, global correspondence can also be detected by utilizing the critical point filter according to the base technology.

[1. 3. 3] Determining the Mapping with Multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, and where possible, mappings at other levels are considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint condition.

We thus define a parent and child relationship between resolution levels. When the following equation (15) holds,

$$( {i}^{′} , {j}^{′} ) = ( ⌊ \frac{i}{2} ⌋ , ⌊ \frac{j}{2} ⌋ ) , \qquad ( 15 )$$

where └x┘ denotes the largest integer not exceeding x, p_{(i′,j′)}^{(m-1,s)} and q_{(i′,j′)}^{(m-1,s)} are respectively called the parents of p_{(i,j)}^{(m,s)} and q_{(i,j)}^{(m1,s)}. Conversely, p_{(i,j)}^{(m,s)} and q_{(i,j)}^{(m,s)} are the child of p_{(i′,j′)}^{(m-1,s)} and the child of q_{(i′,j′)}^{(m-1,s)}, respectively. A function parent (i, j) is defined by the following equation (16):

$$parent ( i , j ) = ( ⌊ \frac{i}{2} ⌋ , ⌊ \frac{j}{2} ⌋ ) \qquad ( 16 )$$

Now, a mapping between p_{(i,j)}^{(m,s)} and q_{(k,l)}^{(m,s)} is determined by computing the energy and finding the minimum thereof. The value of f^{(m,s)} (i, j)=(k, l) is determined as follows using f(m−1, s) (m=1, 2, . . . ,n). First of all, a condition is imposed that q_{(k,l)}^{(m,s)} should lie inside a quadrilateral defined by the following definitions (17) and (18). Then, the applicable mappings are narrowed down by selecting ones that are thought to be reasonable or natural among them satisfying the BC.

q_{g}_{^{(m,s)}}_{(i-1,j-1)}^{(m,s)}q_{g}_{^{(m,s)}}_{(i-1,j+1)}^{(m,s)}q_{g}_{^{(m,s)}}_{(i+1,j+1)}^{(m,s)}q_{g}_{^{(m,s)}}_{(i+1,j-1)}^{(m,s)} (17)

where

g^{(m,s)} (i, j)=f^{(m-1,s)} (parent(i, j))+f^{(m-1,s)} (parent(i, j)+(1,1)) (18)

The quadrilateral defined above is hereinafter referred to as the inherited quadrilateral of p_{(i,j)}^{(m,s)}. The pixel minimizing the energy is sought and obtained inside the inherited quadrilateral.

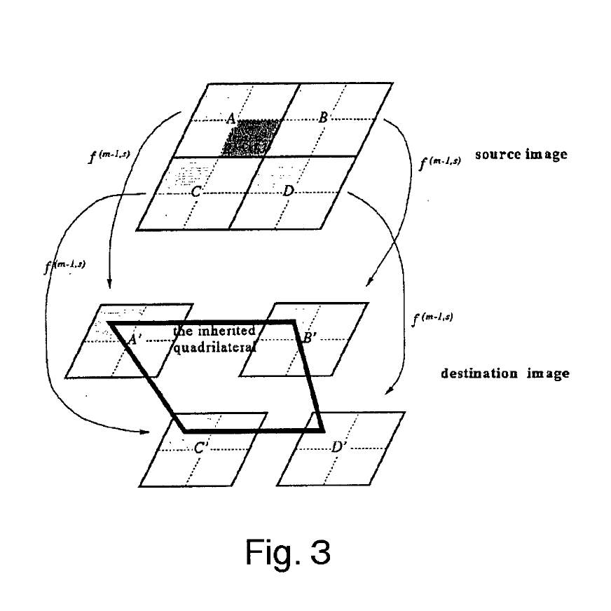

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{^{(m)}}_{(i,j)}^{(m,s)} which exists inside the inherited quadrilateral A′B′C′D′. Thereby, bridging from the mapping at the (m−1)th level to the mapping at the m-th level is achieved.

The energy E₀ defined above may now be replaced by the following equations (19) and (20):

E_{0(i,j)}=∥f^{(m,0)}(i, j)−g^{(m)}(i, j)∥² (19)

E_{0(i,j)}=∥f^{(m,s)}(i, j)−f^{(m,s-1)}(i, j)∥², (1≦i) (20)

for computing the submapping f^{(m, 0)} and the submapping f^{(m, s)} at the m-th level, respectively.

In this manner, a mapping which maintains a low energy of all the submappings is obtained. Using the equation (20) makes the submappings corresponding to the different critical points associated to each other within the same level in order that the subimages can have high similarity. The equation (19) represents the distance between f^{(m, s)} (i, j) and the location where (i, j) should be mapped when regarded as a part of a pixel at the (m−1)the level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m, s)} (i, j). L is increased until such a pixel is found or L reaches its upper bound Lₘₐₓ^{(m)}. Lₘₐₓ^{(m)} is fixed for each level m. If no pixel is found at all, the third condition of the BC is ignored temporarily and such mappings that caused the area of the transformed quadrilateral to become zero (a point or a line) will be permitted so as to determine f^{(m, s)} (i, j). If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will generally be limited to a very small size, and only tiny changes in the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

[1. 4] Automatic Determination of the Optimal Parameter Values

One of the main deficiencies of the existing image matching techniques lies in the difficulty of parameter adjustment. In most cases, the parameter adjustment is performed manually and it is extremely difficult to select the optimal value. However, according to the base technology, the optimal parameter values can be obtained completely automatically.

The systems according to this base technology include two parameters, namely, λ and η, where λ and η represent the weight of the difference of the pixel intensity and the stiffness of the mapping, respectively. In order to automatically determine these parameters, the are initially set to 0. First, λ is gradually increased from λ=0 while η is fixed at 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena occur: p0 1. Pixels which should not be corresponded are erroneously corresponded only because their intensities are close.

2. As a result, correspondence between images becomes inaccurate, and the mapping becomes invalid.

3. As a result, D_{f}^{(m,s)} in equation (14) tends to increase abruptly.

4. As a result, since the value of equation (14) tends to increase abruptly, f^{(m, s)} changes in order to suppress the abrupt increase of D_{f}^{(m,s)}. As a result, C_{f}^{(m,s)} increases.

Therefore, a threshold value at which C_{f}^{(m,s)} turns to an increase from a decrease is detected while a state in which equation (14) takes the minimum value with λ being increased is kept. Such λ is determined as the optimal value at η=0. Next, the behavior of C_{f}^{(m,s)} is examined while η is increased gradually, and η will be automatically determined by a method described later. λ will then again be determined corresponding to such an automatically determined η.

The above-described method resembles the focusing mechanism of human visual systems. In the human visual systems, the images of the respective right eye and left eye are matched while moving one eye. When the objects are clearly recognized, the moving eye is fixed.

[1. 4. 1] Dynamic Determination of λ

Initially, λ is increased from 0 at a certain interval, and a subimage is evaluated each time the value of λ changes. As shown in equation (14), the total energy is defined by λC_{f}^{(m,s)+D}_{f}^{(m,s)}. D_{(i,j)}^{(m,s)} in equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, it is impossible to change the mapping to reduce the total energy unless a changed amount (reduction amount) of the current λC_{(i,j)}^{(m,s)} is equal to or greater than 1. Since D_{f}^{(m,s)} increases by more than 1 accompanied by the change of the mapping, the total energy is not reduced unless λC_{(i,j)}^{(m,s)} is reduced by more than 1.

Under this condition, it is shown that C_{(i,j)}^{(m,s)} decreases in normal cases as λ increases. The histogram of C_{(i,j)}^{(m,s)} is denoted as h(l), where h(l) is the number of pixels whose energy C_{(i,j)}^{(m,s)} is l². In order that λ l²≧1 for example, the case of l²=1/λ is considered. When λ varies from λ₁ to λ₂, a number of pixels (denoted A) expressed by the following equation (21)

$$\begin{matrix}A = {\sum }_{l = ⌈ \frac{1}{{λ}_{2}} ⌉}^{⌊ \frac{1}{{λ}_{2}} ⌋} h ( l ) \\ ≅ {\int }_{l = \frac{1}{{λ}_{2}}}^{\frac{1}{{λ}_{1}}} h ( l ) ⅆ l \\ = - {\int }_{{λ}_{2}}^{{λ}_{1}} h ( l ) \frac{1}{{λ}^{3 / 2}} ⅆ λ \\ = {\int }_{{λ}_{1}}^{{λ}_{2}} \frac{h ( l )}{{λ}^{3 / 2}} ⅆ λ\end{matrix} \qquad ( 21 )$$

changes to a more stable state having the energy shown in equation(22):

$${C}_{f}^{( m , s )} - {l}^{2} = {C}_{f}^{( m , s )} - \frac{1}{λ} . \qquad ( 22 )$$

Here, it is assumed that the energy of these pixels is approximated to be zero. This means that the value of C_{(i,j)}^{(m,s)}. changes by:

$$\partial {C}_{f}^{( m , s )} = - \frac{A}{λ} \qquad ( 23 )$$

As a result, equation (24) holds.

$$\frac{\partial {C}_{f}^{( m , s )}}{\partial λ} = - \frac{h ( l )}{{λ}^{5 / 2}} \qquad ( 24 )$$

Since h(l)>0, C_{f}^{(m,s)} decreases in the normal case. However, when λ exceeds the optimal value, the above phenomenon, that is, an increase in C_{f}^{(m,s)} occurs. The optimal value of λ is determined by detecting this phenomenon.

When

$$h ( l ) = H {l}^{k} = \frac{H}{{λ}^{k / 2}} \qquad ( 25 )$$

is assumed, where both H(H>0) and k are constants, the equation (26) holds:

$$\frac{\partial {C}_{f}^{( m , s )}}{\partial λ} = - \frac{H}{{λ}^{5 / 2 + k / 2}} \qquad ( 26 )$$

Then, if k≠−3, the following equation (27) holds:

$${C}_{f}^{( m , s )} = C + \frac{H}{( 3 / 2 + k / 2 ) {λ}^{3 / 2 + k / 2}} \qquad ( 27 )$$

The equation (27) is a general equation of C_{f}^{(m,s)} (where C is a constant).

When detecting the optimal value of λ, the number of pixels violating the BC may be examined for safety. In the course of determining a mapping for each pixel, the probability of violating the BC is assumed as a value p₀ here. In this case, since

$$\frac{\partial A}{\partial λ} = \frac{h ( l )}{{λ}^{3 / 2}} \qquad ( 28 )$$

holds, the number of pixels violating the BC increases at a rate of:

$${B}_{0} = \frac{h ( l ) {p}_{0}}{{λ}^{3 / 2}} \qquad ( 29 )$$

Thus,

$$\frac{{B}_{0} {λ}^{3 / 2}}{{p}_{0} h ( l )} = 1 \qquad ( 30 )$$

is a constant. If it is assumed that h(l)=Hl^{k}, the following equation (31), for example,

B₀λ^{3/2+k/2}=p₀H (31)

becomes a constant. However, when λ exceeds the optimal value, the above value of equation (31) increases abruptly. By detecting this phenomenon, i.e. whether or not the value of B₀λ^{3/2+k/2}/2^{m} exceeds an abnormal value B₀ₜₕᵣₑₛ, the optimal value of λ can be determined. Similarly, whether or not the value of B₁λ^{3/2+k/2}/2^{m} exceeds an abnormal value B₁ₜₕᵣₑₛ can be used to check for an increasing rate B₁ of pixels violating the third condition of the BC. The reason why the factor 2^{m} is introduced here will be described at a later stage. This system is not sensitive to the two threshold values B₀ₜₕᵣₑₛ and B₁ₜₕᵣₑₛ. The two threshold values B₀ₜₕᵣₑₛ and B₁ₜₕᵣₑₛ can be used to detect excessive distortion of the mapping which may not be detected through observation of the energy C_{f}^{(m,s)}.

In the experimentation, when λ exceeded 0.1 the computation of f^{(m, s)} was stopped and the computation of f^{(m, s+1)} was started. That is because the computation of submappings is affected by a difference of only 3 out of 255 levels in pixel intensity when λ>0.1 and it is then difficult to obtain a correct result.

[1. 4. 2] Histogram h(l)

The examination of C_{f}^{(m,s)} does not depend on the histogram h(l), however, the examination of the BC and its third condition may be affected by h(l). When (λ , C_{f}^{(m,s)}) is actually plotted, k is usually close to 1. In the experiment, k=1 is used, that is, B₀λ² and B₁λ² are examined. If the true value of k is less than 1, B₀λ² and B₁λ² are not constants and increase gradually by a factor of λ^{(1-k)/2}. If h(l) is a constant, the factor is, for example, λ^{1/2}. However, such a difference can be absorbed by setting the threshold B₀ₜₕᵣₑₛ appropriately.

Let us model the source image by a circular object, with its center at(x₀,y₀) and its radius r, given by:

$$p ( i , j ) = \{ \begin{matrix} \frac{255}{r} c ( \sqrt{{( i - {x}_{0} )}^{2} + {( j - {y}_{0} )}^{2}} ) … ( \sqrt{{( i - {x}_{0} )}^{2} + {( j - {y}_{0} )}^{2}} \leq r ) \\ 0 … ( o t h e r w i s e )\end{matrix} \qquad ( 32 )$$

and the destination image given by:

$$q ( i , j ) = \{ \begin{matrix} \frac{255}{r} c ( \sqrt{{( i - {x}_{1} )}^{2} + {( j - {y}_{1} )}^{2}} ) … ( . \sqrt{{( i - {x}_{1} )}^{2} + {( j - {y}_{1} )}^{2}} \leq r ) \\ 0 … ( o t h e r w i s e )\end{matrix} \qquad ( 33 )$$

with its center at (x₁, y₁) and radius r. In the above, let c(x) have the form of c(x)=x^{k}. When the centers (x₀, y₀) and (x₁, y₁) are sufficiently far from each other, the histogram h(l) is then in the form:

h(l)∝rl^{k} (k≠0) (34)

When k=1, the images represent objects with clear boundaries embedded in the background. These objects become darker toward their centers and brighter toward their boundaries. When k=−1, the images represent objects with vague boundaries. These objects are brightest at their centers, and become darker toward their boundaries. Without much loss of generality, it suffices to state that objects in images are generally between these two types of objects. Thus, choosing k such that −1≦k≦1 can cover most cases and the equation (27) is generally a decreasing function for this range.

As can be observed from the above equation (34), attention must be directed to the fact that r is influenced by the resolution of the image, that is, r is proportional to 2^{m}. This is the reason for the factor 2^{m} being introduced in the above section [1.4.1].

[1. 4. 3] Dynamic Determination of η

The parameter η can also be automatically determined in a similar manner. Initially, η is set to zero, and the final mapping f⁽ⁿ⁾ and the energy C_{f}⁽ⁿ⁾ at the finest resolution are computed. Then, after η is increased by a certain value Δη, the final mapping f⁽ⁿ⁾ and the energy C_{f}⁽ⁿ⁾ at the finest resolution are again computed. This process is repeated until the optimal value of η is obtained. η represents the stiffness of the mapping because it is a weight of the following equation (35):

E_{0(i,j)}^{(m,s)}=∥f^{(m,s)}(i, j)−f^{(m,s-1)}(i, j)∥² (35)

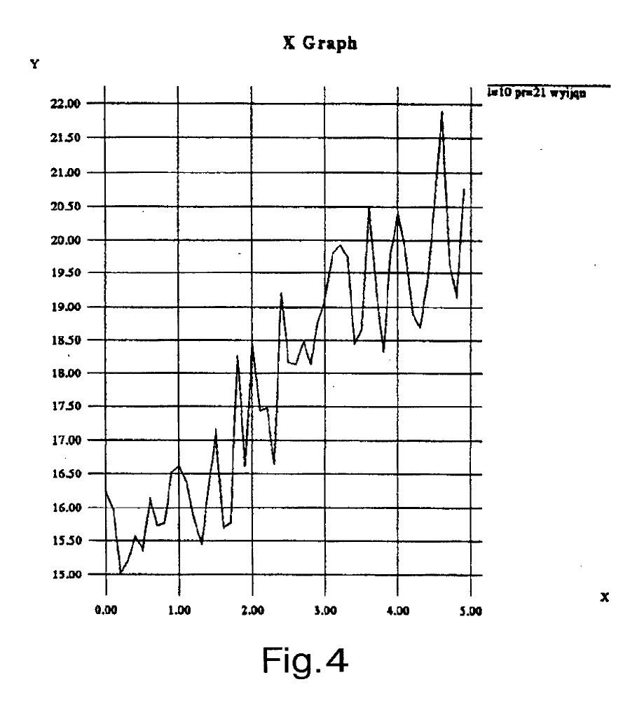

If η is zero, D_{f}⁽ⁿ⁾ is determined irrespective of the previous submapping, and the present submapping may be elastically deformed and become too distorted. On the other hand, if η is a very large value, D_{f}⁽ⁿ⁾ is almost completely determined by the immediately previous submapping. The submappings are then very stiff, and the pixels are mapped to almost the same locations. The resulting mapping is therefore the identity mapping. When the value of η increases from 0, C_{f}⁽ⁿ⁾ gradually decreases as will be described later. However, when the value of η exceeds the optimal value, the energy starts increasing as shown in FIG. 4. In FIG. 4, the x-axis represents η, and y-axis represents C_{f}.

The optimum value of η which minimizes C_{f}⁽ⁿ⁾ can be obtained in this manner. However, since various elements affect this computation as compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of λ. Thus, whether the obtained value of C_{f}⁽ⁿ⁾ is the minimum or not cannot be determined as easily. When candidates for the minimum value are found, the true minimum needs to be searched by setting up further finer intervals.

[1. 5] Supersampling

When deciding the correspondence between the pixels, the range of f^{(m, s)} can be expanded to R×R (R being the set of real numbers) in order to increase the degree of freedom. In this case, the intensity of the pixels of the destination image is interpolated, to provide f^{(m, s)} having an intensity at non-integer points:

V(q_{f}_{^{(m,s)}}_{(i,j)}^{(m,s)}) (36)

That is, supersampling is performed. In an example implementation, f^{(m,s)} may take integer and half integer values, and

V(q_{(i,j)+(0.5,0.5)}^{(m,s)}) (37)

is given by

(V(q_{(i,j)}^{(m,s)})+V(q_{(i,j)+(1,1)}^{(m,s)}))/2 (38)

[1. 6] Normalization of the Pixel Intensity of Each image

When the source and destination images contain quite different objects, the raw pixel intensity may not be used to compute the mapping because a large difference in the pixel intensity causes excessively large energy C_{f}^{(m,s)} and thus making it difficult to obtain an accurate evaluation.

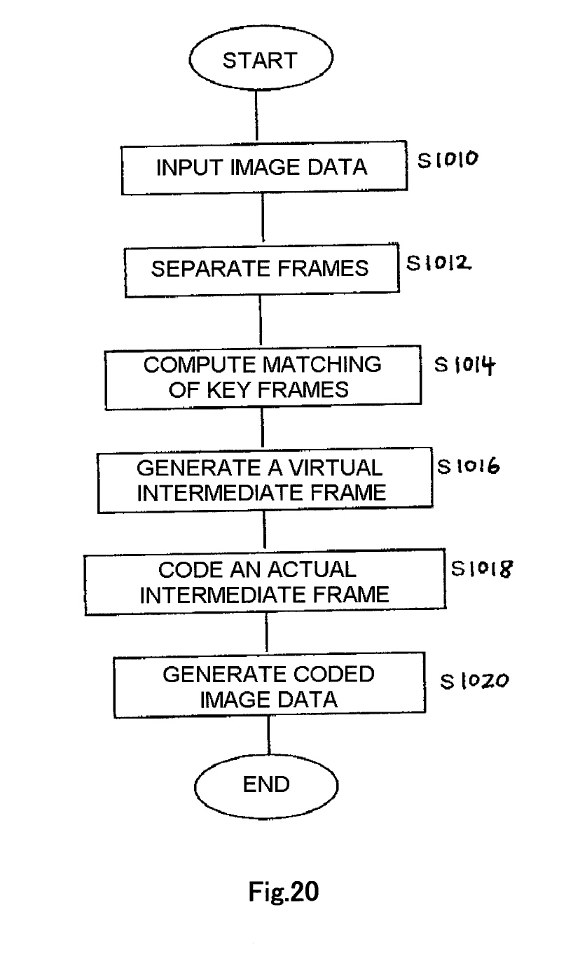

For example, a matching between a human face and a cat's face is computed as shown in FIGS. 20(a) and 20(b). The cat's face is covered with hair and is a mixture of very bright pixels and very dark pixels. In this case, in order to compute the submappings of the two faces, subimages are normalized. That is, the darkest pixel intensity is set to 0 while the brightest pixel intensity is set to 255, and other pixel intensity values are obtained using linear interpolation.

[1. 7] Implementation

In an example implementation, a heuristic method is utilized wherein the computation proceeds linearly as the source image is scanned. First, the value of f^{(m, s)} is determined at the top leftmost pixel (i, j)=(0, 0). The value of each f^{(m, s)} (i, j) is then determined while i is increased by one at each step. When i reaches the width of the image, j is increased by one and i is reset to zero. Thereafter, f^{(m, s)} (i, j) is determined while scanning the source image. Once pixel correspondence is determined for all the points, it means that a single mapping f^{(m, s)} is determined.

When a corresponding point q_{f(i, j)} is determined for p_{(i, j)}, a corresponding point q_{f(i, j+1)} of p_{(i, j+1)} is determined next. The position of q_{f(i, j+1)} is constrained by the position of q_{f(i, j)} since the position of q_{f(i, j+1)} satisfies the BC. Thus, in this system, a point whose corresponding point is determined earlier is given higher priority. If the situation continues in which (0, 0) is always given the highest priority, the final mapping might be unnecessarily biased. In order to avoid this bias, f^{(m, s)} is determined in the following manner in the base technology.

First, when (s mod 4) is 0, f^{(m, s)} is determined starting from (0, 0) while gradually increasing both i and j. When (s mod 4) is 1, f^{(m, s)} is determined starting from the top rightmost location while decreasing i and increasing j. When (s mod 4) is 2, f^{(m, s)} is determined starting from the bottom rightmost location while decreasing both i and j. When (s mod 4) is 3, f^{(m, s)} is determined starting from the bottom leftmost location while increasing i and decreasing j. Since a concept such as the submapping, that is, a parameter s, does not exist in the finest n-th level, f^{(m, s)} is computed continuously in two directions on the assumption that s=0 and s=2.

In this implementation, the values of f^{(m, s)} (i, j) (m=0, . . . ,n) that satisfy the BC are chosen as much as possible from the candidates (k, l) by imposing a penalty on the candidates violating the BC. The energy D_{(k, l)} of a candidate that violates the third condition of the BC is multiplied by φ and that of a candidate that violates the first or second condition of the BC is multiplied by ψ. In this implementation, φ=2 and ψ=100000 are used.

In order to check the above-mentioned BC, the following test may be performed as the procedure when determining (k, l)=f^{(m, s)} (i, j). Namely, for each grid point (k, l) in the inherited quadrilateral of f^{(m, s)} (i, j), whether or not the z-component of the outer product of

W=\vec{A}×\vec{B} (39)

is equal to or greater than 0 is examined, where

\vec{A}={right arrow over (q_{f}_{^{(m,s)}}_{(i,j-1)}^{(m,s)}q_{f}_{^{(m,s)}}_{(i+1,j-1)}^{(m,s)})} (40)

\vec{B}={right arrow over (q_{f}_{^{(m,s)}}_{(i,j-1)}^{(m,s)}q_{(k,l)}^{(m,s)})} (41)

Here, the vectors are regarded as 3D vectors and the z-axis is defined in the orthogonal right-hand coordinate system. When W is negative, the candidate is imposed with a penalty by multiplying D_{(k,l)}^{(m,s)} by ψ so that it is not as likely to be selected.

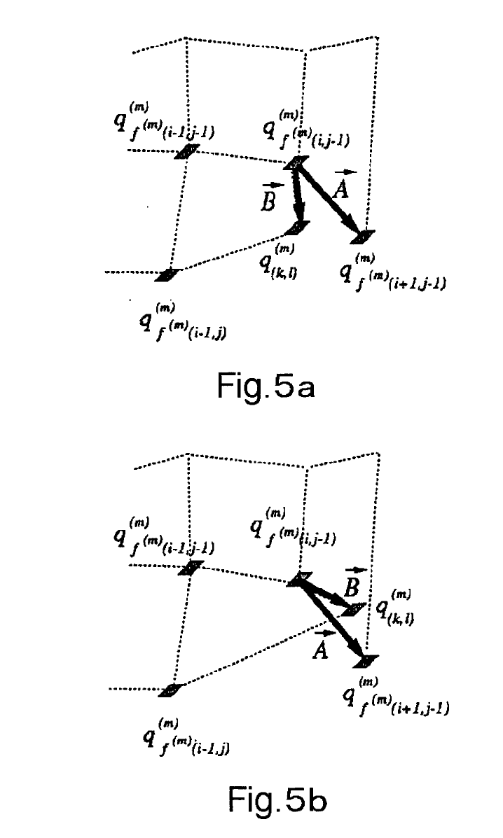

FIGS. 5(a) and 5(b) illustrate the reason why this condition is inspected. FIG. 5(a) shows a candidate without a penalty and FIG. 5(b) shows one with a penalty. When determining the mapping f^{(m, s)} (i, j+1) for the adjacent pixel at (i, j+1), there is no pixel on the source image plane that satisfies the BC if the z-component of W is negative because then q_{(k,l)}^{(m,s)} passes the boundary of the adjacent quadrilateral.

[1. 7. 1] The Order of Submappings

In this implementation, σ (0)=0, σ (1)=1, σ (2)=2, σ (3)=3, σ (4)=0 are used when the resolution level is even, while σ (0)=3, σ (1)=2, σ (2)=1, σ (3)=0, σ (4)=3 are used when the resolution level is odd. Thus, the submappings are shuffled to some extent. It is to be noted that the submappings are primarily of four types, and s may be any of 0 to 3. However, a processing with s=4 is used in this implementation for a reason to be described later.

[1. 8] Interpolations

After the mapping between the source and destination images is determined, the intensity values of the corresponding pixels are interpolated. In the implementation, trilinear interpolation is used. Suppose that a square p_{(i, j)}p_{(i+1, j)}p_{(i+1, j+1)}p_{(i, j+1)} on the source image plane is mapped to a quadrilateral q_{f(i, j)}q_{f(i+1, j)}q_{f(i+1, j+1)}q_{f(i, j+1)} on the destination image plane. For simplicity, the distance between the image planes is assumed to be 1. The intermediate image pixels r(x,y,t) (0≦x≦N−1, 0≦y≦M−1) whose distance from the source image plane is t (0≦t≦1) are obtained as follows. First, the location of the pixel r(x,y,t), where x,y,tεR, is determined by equation (42):

$$\begin{matrix}( x , y ) = ( 1 - d x ) ( 1 - d y ) ( 1 - t ) ( i , j ) + ( 1 - d x ) ( 1 - d y ) \\ tf ( i , j ) + d x ( 1 - d y ) ( 1 - t ) ( i + 1 , j ) + dx ( 1 - dy ) \\ tf ( i + 1 , j ) + ( 1 - dx ) dy ( 1 - t ) ( i , j + 1 ) + ( 1 - dx ) \\ dytf ( i , j + 1 ) + dxdy ( 1 - t ) ( i + 1 , j + 1 ) + \\ dxdytf ( i + 1 , j + 1 )\end{matrix} \qquad ( 42 )$$

The value of the pixel intensity at r(x,y,t) is then determined by equation (43):

$$\begin{matrix}V ( r ( x , y , t ) ) = ( 1 - dx ) ( 1 - dy ) ( 1 - t ) V ( {p}_{( i , j )} ) + ( 1 - dx ) \\ ( 1 - dy ) tV ( {q}_{f ( i , j )} ) + dx ( 1 - dy ) ( 1 - t ) \\ V ( {p}_{( i + 1 , j )} ) + dx ( 1 - dy ) tV ( {q}_{f ( i + 1 , j )} ) + \\ ( 1 - dx ) dy ( 1 - t ) V ( {p}_{( i , j + 1 )} ) + ( 1 - dx ) \\ dytV ( {q}_{f ( i , j + 1 )} ) + dxdy ( 1 - t ) V ( {p}_{( i + 1 , j + 1 )} ) + \\ dxdytV ( {q}_{f ( i + 1 , j + 1 )} )\end{matrix} \qquad ( 43 )$$

where dx and dy are parameters varying from 0 to 1.

[1. 9] Mapping to Which Constraints are Imposed

So far, the determination of a mapping in which no constraints are imposed has been described. However, if a correspondence between particular pixels of the source and destination images is provided in a predetermined manner, the mapping can be determined using such correspondence as a constraint.

The basic idea is that the source image is roughly deformed by an approximate mapping which maps the specified pixels of the source image to the specified pixels of the destination image and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of a specified pixel are mapped to locations near the position to which the specified one is mapped. Here, the approximate mapping at the m-th level in the resolution hierarchy is denoted by F^{(m)}.

The approximate mapping F is determined in the following manner. First, the mappings for several pixels are specified. When nₛ pixels

p(i₀, j₀), p(i₁, j₁), . . . , p(iₙ_{ₛ}₋₁, jₙ_{ₛ}₋₁) (44)

of the source image are specified, the following values in the equation (45) are determined.

F⁽ⁿ⁾(i₀, j₀)=(k₀, l₀), F⁽ⁿ⁾(i₁, j₁)=(k₁, l₁), . . . , F⁽ⁿ⁾(iₙ_{ₛ}₋₁, jₙ_{ₛ}₋₁)=(kₙ_{ₛ}₋₁, lₙ_{ₛ}₋₁), (45)

For the remaining pixels of the source image, the amount of displacement is the weighted average of the displacement of P (iₕ, jₕ) (h=0, . . . , nₛ−1). Namely, a pixel p_{(i, j)} is mapped to the following pixel (expressed by the equation (46)) of the destination image.

$${F}^{( m )} ( i , j ) = \frac{( i , j ) + {\sum }_{h = 0}^{h = {n}_{s} - 1} ( {k}_{h} - {i}_{h} , {l}_{h} - {j}_{h} ) w e i g h {t}_{h} ( i , j )}{{2}^{n - m}} \qquad ( 46 )$$

where

$$w e i g h {t}_{h} ( i , j ) = \frac{1 / {‖ ( {i}_{h} - i , {j}_{h} - j ) ‖}^{2}}{total\_weight ( i , j )} \qquad ( 47 )$$

where

$$total\_weight ( i , j ) = {\sum }_{h = 0}^{h = {n}_{s} - 1} 1 / {‖ ( {i}_{h} - i , {j}_{h} - j ) ‖}^{2} \qquad ( 48 )$$

Second, the energy D_{(i,j)}^{(m,s)} of the candidate mapping f is changed so that a mapping f similar to F^{(m)} has a lower energy. Precisely speaking, D_{(i,j)}^{(m,s)} is expressed by the equation (49):

D_{(i,j)}^{(m,s)}=E₀_{_{(i,j)}}^{(m,s)}+ηE₁_{_{(i,j)}}^{(m,s)}+κE₂_{_{(i,j)}}^{(m,s)} (49)

where

$${E}_{{2}_{( i , j )}}^{( m s )} = \{ \begin{matrix}0 , & i f {‖ {F}^{( m )} ( i , j ) - {f}^{( m , s )} ( i , j ) ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , & o t h e r w i s e\end{matrix} \qquad ( 50 )$$

where κ, ρ≧0. Finally, the resulting mapping f is determined by the above-described automatic computing process.

Note that E₂_{_{(i,j)}}^{(m,s)} becomes 0 if f^{(m, s)} (i, j) is sufficiently close to F^{(m)} (i, j) i.e., the distance therebetween is equal to or less than

$$⌊ \frac{{ρ}^{2}}{{2}^{2 ( n - m )}} ⌋ \qquad ( 51 )$$

This has been defined in this way because it is desirable to determine each value f^{(m, s)} (i, j) automatically to fit in an appropriate place in the destination image as long as each value f^{(m, s)} (i, j) is close to F^{(m)} (i, j). For this reason, there is no need to specify the precise correspondence in detail to have the source image automatically mapped so that the source image matches the destination image.

[2] Concrete Processing Procedure

The flow of a process utilizing the respective elemental techniques described in [1] will now be described.

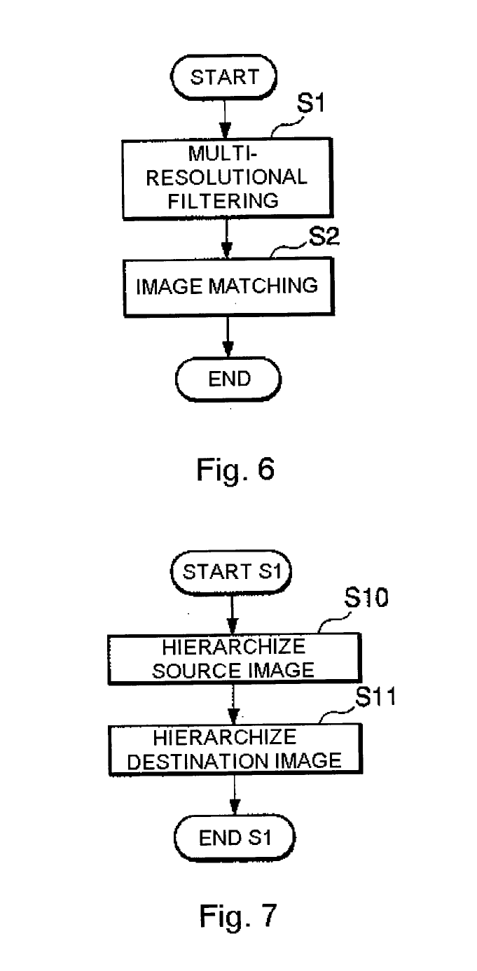

FIG. 6 is a flowchart of the overall procedure of the base technology. Referring to FIG. 6, a source image and destination image are first processed using a multiresolutional critical point filter (S1). The source image and the destination image are then matched (S2). As will be understood, the matching (S2) is not required in every case, and other processing such as image recognition may be performed instead, based on the characteristics of the source image obtained at S1.

FIG. 7 is a flowchart showing details of the process S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel. It may also be possible to process a number of source and destination images as required by subsequent processes.

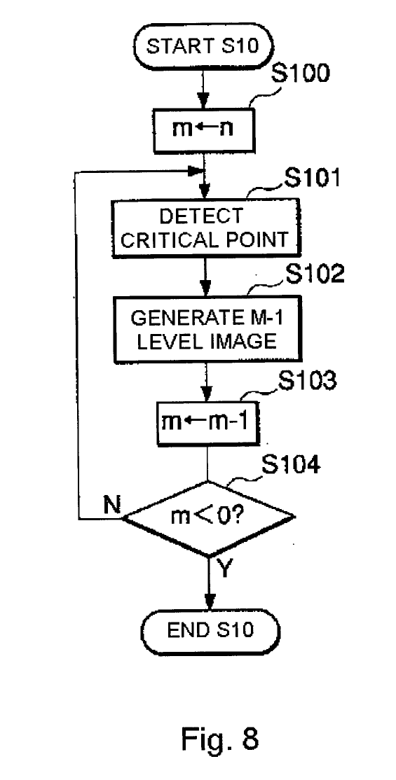

FIG. 8 is a flowchart showing details of the process at S10 shown in FIG. 7. Suppose that the size of the original source image is 2ⁿ×2ⁿ. Since source hierarchical images are sequentially generated from an image with a finer resolution to one with a coarser resolution, the parameter m which indicates the level of resolution to be processed is set to n (S100). Then, critical points are detected from the images p^{(m, 0)}, p^{(m, 1)}, p^{(m, 2)} and p^{(m, 3)} of the m-th level of resolution, using a critical point filter (S101), so that the images p^{(m-1, 0)} p^{(m-1, 1)}, p^{(m-1, 2)} and p^{(m-1, 3)} of the (m−1)th level are generated (S102). Since m=n here, p^{(m, 0)}=p^{(m, 1)}=p^{(m, 2)}=p^{(m, 3)}=p⁽ⁿ⁾ holds and four types of subimages are thus generated from a single source image.

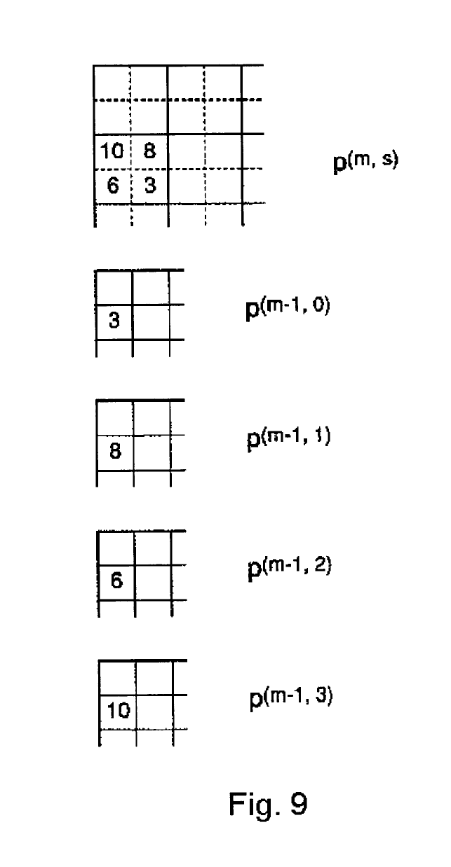

FIG. 9 shows correspondence between partial images of the m-th and those of (m−1)th levels of resolution. Referring to FIG. 9, respective numberic values shown in the figure represent the intensity of respective pixels. p^{(m, s)} symbolizes any one of four images p^{(m, 0)} through p^{(m, 3)}, and when generating p^{(m-1, 0)}, p^{(m, 0)} is used from p^{(m, s)}. For example, as for the block shown in FIG. 9, comprising four pixels with their pixel intensity values indicated inside, images p^{(m-1, 0)}, p^{(m-1, 1)}, p^{(m-1, 2)} and p^{(m-1, 3)} acquire “3”, “8”, “6”and “10”, respectively, according to the rules described in [1.2]. This block at the m-th level is replaced at the (m−1)th level by respective single pixels thus acquired. Therefore, the size of the subimages at the (m−1)th level is 2^{m-1}×2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0 (0-th level) are generated to complete the process at S10. The size of the subimages at the 0-th level is 1×1.

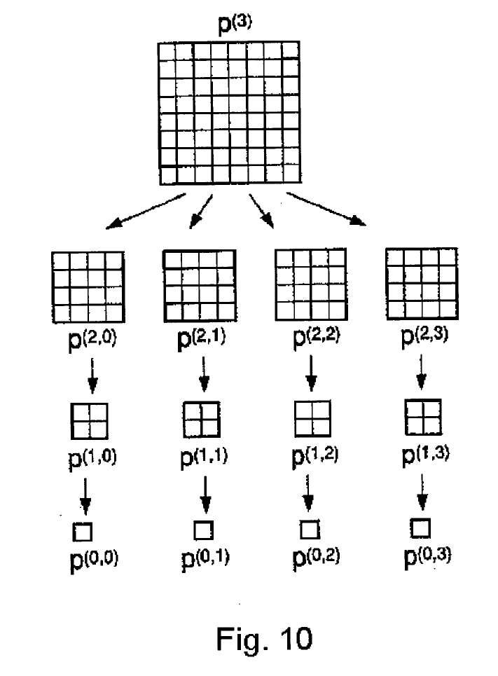

FIG. 10 shows source hierarchical images generated at S10 in the case of n=3. The initial source image is the only image common to the four series followed. The four types of subimages are generated independently, depending on the type of critical point. Note that the process in FIG. 8 is common to S11 shown in FIG. 7, and that destination hierarchical images are generated through a similar procedure. Then, the process at S1 in FIG. 6 is completed.

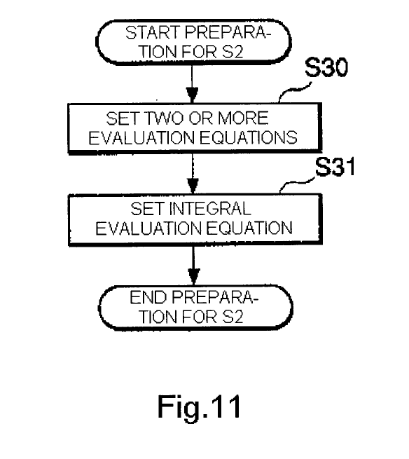

In this base technology, in order to proceed to S2 shown in FIG. 6 a matching evaluation is prepared. FIG. 11 shows the preparation procedure. Referring to FIG. 11, a plurality of evaluation equations are set (S30). The evaluation equations may include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such a combined evaluation equation may be λC_{(i,j)}^{(m,s)}+D_{f}^{(m,s)}. Using η introduced in [1.3.2.2] we have

ΣΣ(λC_{(i,j)}^{(m,s)}+ηE_{0(i,j)}^{(m,s)}+E_{1(i,j)}^{(m,s)}) (52)

In the equation (52) the sum is taken for,each i and j where i and j run through 0, 1, . . . , 2^{m-1}. Now, the preparation for matching evaluation is completed.

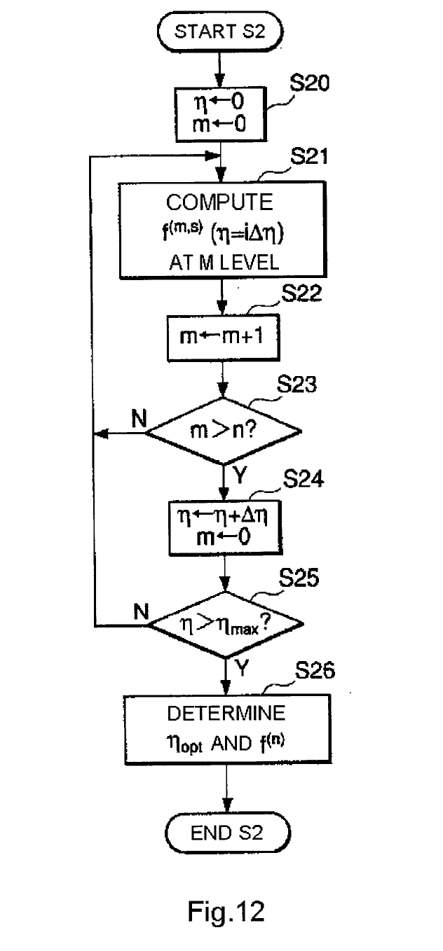

FIG. 12 is a flowchart showing the details of the process of S2 shown in FIG. 6. As described in [1], the source hierarchical images and destination hierarchical images are matched between images having the same level of resolution. In order to detect global correspondence correctly, a matching is calculated in sequence from a coarse level to a fine level of resolution. Since the source and destination hierarchical images are generated using the critical point filter, the location and intensity of critical points are stored clearly even at a coarse level. Thus, the result of the global matching is superior to conventional methods.

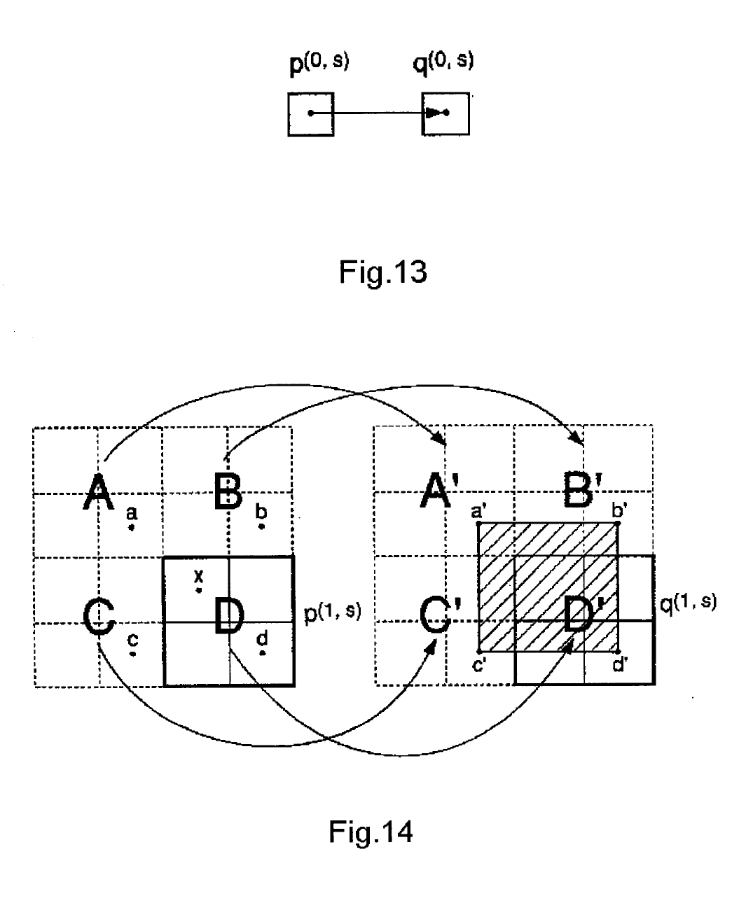

Referring to FIG. 12, a coefficient parameter η and a level parameter m are set to 0 (S20). Then, a matching is computed between the four subimages at the m-th level of the source hierarchical images and those of the destination hierarchical images at the m-th level, so that four types of submappings f^{(m, s)} (s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching. This is called a vertical reference between different levels. If m=0, there is no coarser level and this exceptional case will be described using FIG. 13.

A horizontal reference within the same level is also performed. As indicated by the equation (20) in [1.3.3], f^{(m, 3)}, f^{(m, 2)} and f^{(m, 1)} are respectively determined so as to be analogous to f^{(m, 2)}, f^{(m, 1)} and f^{(m, 0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m, 0)}, which is to be initially determined, a coarser level by one may be referred to since there is no other submapping at the same level to be referred to as shown in the equation (19). In this base technology, however, a procedure is adopted such that after the submappings were obtained up to f^{(m, 3)}, f^{(m, 0)} is recalculated once utilizing the thus obtained subamppings as a constraint. This procedure is equivalent to a process in which s=4 is substituted into the equation (20) and f^{(m, 4)} is set to f^{(m, 0)} anew. The above process is employed to avoid the tendency in which the degree of association between f^{(m, 0)} and f^{(m, 3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

FIG. 13 illustrates how the submapping is determined at the 0-th level. Since at the 0-th level each sub-image is consitituted by a single pixel, the four submappings f^{(0, s)} are automatically chosen as the identity mapping. FIG. 14 shows how the submappings are determined at the first level. At the first level, each of the sub-images is constituted of four pixels, which are indicated by solid lines. When a corresponding point (pixel) of the point (pixel) x in p^{(1, s)} is searched within q^{(1, s)}, the following procedure is adopted:

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the pixels A to C are virtual pixels which do not exist in reality.

3. The corresponding points A′ to D′ of the pixels A to D, which have already been defined at the 0-th level, are plotted in q^{(1, s)}. The pixels A′ to C′ are virtual pixels and regarded to be located at the same positions as the pixels A to C.

4. The corresponding point a′ to-the point a in the pixel A is regarded as being located inside the pixel A′, and the point a′ is plotted. Then, it is assumed that the position occupied by the point a in the pixel A (in this case, positioned at the lower right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum in the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels (higher than the second level), the pixels A′ to D′ will be positioned apart from one another as shown in FIG. 3.

Once the four submappings at the m-th level are determined in this manner, m is incremented (S22 in FIG. 12). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾ (η=0) because it has been determined relative to η=0.

Next, to obtain the mapping with respect to other different η, η is shifted by Δη and m is reset to zero (S24). After confirming that new η does not exceed a predetermined search-stop value ηₘₐₓ(S25), the process returns to S21 and the mapping f⁽ⁿ⁾ (η=Δη) relative to the new η is obtained. This process is repeated while obtaining f⁽ⁿ⁾ (η=iΔη) (i=0,1, . . . ) at S21. When η exceeds ηₘₐₓ, the process proceeds to S26 and the optimal η=ηₒₚₜ is determined using a method described later, so as to let f⁽ⁿ⁾ (η=ηₒₚₜ) be the final mapping f⁽ⁿ⁾.

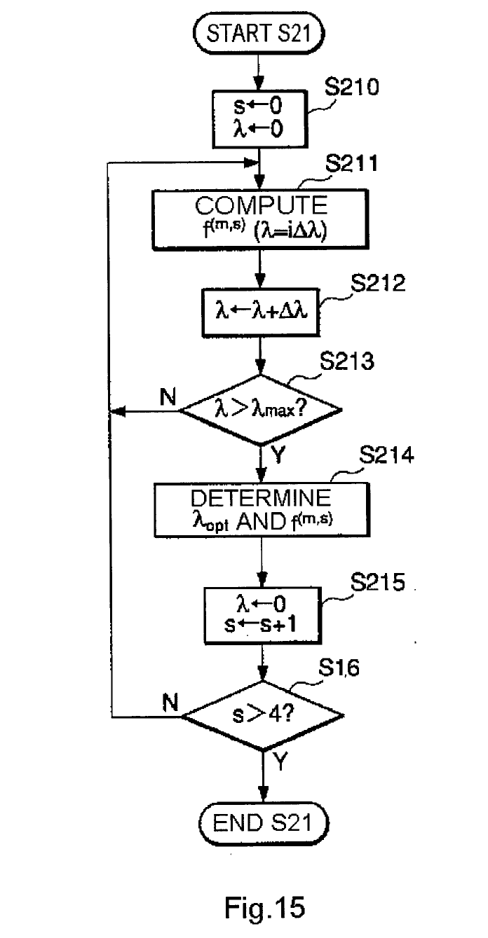

FIG. 15 is a flowchart showing the details of the process of S21 shown in FIG. 12. According to this flowchart, the submappings at the m-th level are determined for a certain predetermined η. In this base technology, when determining the mappings, the optimal λ is defined independently for each submapping.

Referring to FIG. 15, s and λ are first reset to zero (S210). Then, obtained is the submapping f^{(m, s)} that minimizes the energy with respect to the then λ (and, implicitly, η) (S211), and the thus obtained submapping is denoted as f^{(m, s)} (λ=0). In order to obtain the mapping with respect to other different λ, λ is shifted by Δλ. After confirming that the new λ does not exceed a predetermined search-stop value λₘₐₓ (S213), the process returns to S211 and the mapping f^{(m, s)} (λ=Δλ) relative to the new λ is obtained. This process is repeated while obtaining f^{(m, s)} (λ=iΔλ) (i=0,1, . . . ). When λ exceeds λₘₐₓ, the process proceeds to S214 and the optimal λ=λₒₚₜ is determined, so as to let f^{(m, s)} (λ=λₒₚₜ) be the final mapping f^{(m, s)} (S214).

Next, in order to obtain other submappings at the same level, λ is reset to zero and s is incremented (S215). After confirming that s does not exceed 4 (S216), return to S211. When s=4, f^{(m, s)} is renewed utilizing f^{(m, 3)} as described above and a submapping at that level is determined.

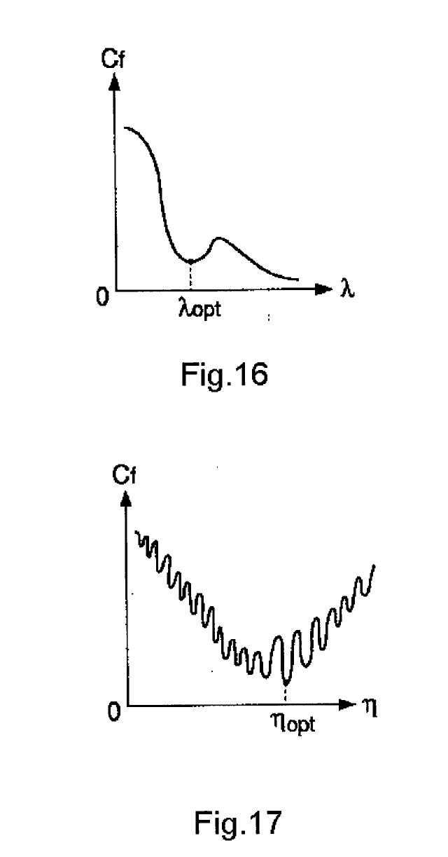

FIG. 16 shows the behavior of the energy C_{f}^{(m, s)} corresponding to f^{(m, s)} (λ=iΔλ)(i=0,1, . . . ) for a certain m and s while varying λ. As described in [1.4], as λ increases, C_{f}^{(m, s)} normally decreases but changes to increase after λ exceeds the optimal value. In this base technology, λ in which C_{f}^{(m, s)} becomes the minima is defined as λₒₚₜ. As observed in FIG. 16, even if C_{f}^{(m, s)} begins to decrease again in the range λ>λₒₚₜ, the mapping will not be as good. For this reason, it suffices to pay attention to the first occurring minima value. In this base technology, λₒₚₜ is independently determined for each submapping including f⁽ⁿ⁾.

FIG. 17 shows the behavior of the energy C_{f}⁽ⁿ⁾ corresponding to f⁽ⁿ⁾ (η=iΔη) (i=0,1, . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to object recognition, characteristic extraction, and image matching. As a result, it is possible to construct an image processing system which significantly reduces manual labor.

Some further extensions to or modifications of the above-described base technology may be made as follows:

(1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extrema in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as 1/E₁ and 1/E₂, may be employed. A combined evaluation equation is not necessarily a linear sum, but an n-powered sum (n=2, ½, −1, −2, etc.), a polynomial or an arbitrary function may be employed when appropriate.

The system may employ a single parameter such as the above α, two parameters such as η and λ as in the base technology, or more than two parameters. When there are more than three parameters used, they may be determined while changing one at a time.

(2) In the base technology, a parameter is determined in a two-step process. That is, in such a manner that a point at which C_{f}^{(m, s)} takes the minima is detected after a mapping such that the value of the combined evaluation equation becomes minimum is determined. However, instead of this two-step processing, a parameter may be effectively determined, as the case may be, in a manner such that the minimum value of a combined evaluation equation becomes minimum. In this case, αE₀+βE₁, for example, may be used as the combined evaluation equation, where α+β=1 may be imposed as a constraint so as to equally treat each evaluation equation. The automatic determination of a parameter is effective when determining the parameter such that the energy becomes minimum.

(3) In the base technology, four types of submappings related to four types of critical points are generated at each level of resolution. However, one, two, or three types among the four types may be selectively used. For instance, if there exists only one bright point in an image, generation of hierarchical images based solely on f^{(m, 3)} related to a maxima point can be effective to a certain degree. In this case, no other submapping is necessary at the same level, thus the amount of computation relative on s is effectively reduced.

(4) In the base technology, as the level of resolution of an image advances by one through a critical point filter, the number of pixels becomes ¼. However, it is possible to suppose that one block consists of 3×3 pixels and critical points are searched in this 3×3, block, then the number of pixels will be 1/9 as the level advances by one.

(5) In the base technology, if the source and the destination images are color images, they would generally first be converted to monochrome images, and the mappings then computed. The source color images may then be transformed by using the mappings thus obtained. However, as an alternate method, the submappings may be computed regarding each RGB component.

Image Data Coding Technology

An image data coding technology utilizing the above-described base technology will now be described. First, an image data coding technology proposed in pending Japanese Patent Application No. 2001-21098, owned by the same assignee and hereby incorporated by reference herein, will be briefly described. Thereafter, further novel and advantageous processes according to the present invention will be described in the section “Embodiments for Image Data Coding and Decoding Techniques.”

FIG. 18 is a conceptual diagram showing a process for coding image data. Here, it is assumed that the image data is made up of frames including key frames and intermediate frames, which are frames other than key frames. The key frames may be determined from the outset, or may be determined during coding. The image data may be, for example, a standard moving picture or medical image data or the like formed of a plurality of frames. Processes for determining the key frames are known in the art and are not described here.

Referring to FIG. 18, suppose that two key frames (KF) 200 and 202 are given. First, a matching between these key frames is computed so as to generate a virtual intermediate frame (VIF) 204. The processes for matching and generating an intermediate frame are described in detail in the base technology above, however, in the base technology, the two key frames to which the matching is computed are called the source image and the destination image. Note that the “virtual intermediate frame (VIF)” is not an actual intermediate frame that is included in the initial image data (that is, the actual intermediate frame) but a frame obtained from the key frames based on the matching computation.

Next, an actual intermediate frame (AIF) 206 is coded using the virtual intermediate frame VIF 204. For example, if the actual intermediate frame AIF 206 is located at a point which interior divides the two key frames KF 200 and 202 by a ratio t:(1−t), then the virtual intermediate frame VIF 204 is similarly interpolated on the same assumption that VIF 204 is located at the point which interior-divides the key frames 200 and 202 by the ratio t:(1−t). The VIF 204 may be interpolated by the trilinear method (see [1.8] in the base technology) using a quadrilateral or the like whose vertices are the corresponding points (that is, interpolated in the two directions x and y). Moreover, a technique other than trilinear may also be used here. For example, the interpolation may be performed simply between the corresponding points without considering a quadrilateral.

In this example, the coding of the actual intermediate frame AIF 206 is realized such that a difference image DI 210 between the AIF 206 and the virtual intermediate frame VIF 204 is determined and encoded by, for example, the entropy coding (such as the Huffman coding and arithmetic coding), a JPEG coding using the DCT (Discrete Cosine Transform), dictionary based compression or the run-length coding, and so forth. Final coded data of the image data (hereinafter also simply referred to as coded image data) are acquired as a combination of the coded data of the difference image relating to this intermediate frame (hereafter simply referred to as coded data of the intermediate frame) and the key frame data.

In the above method, the same virtual intermediate frames are obtained from the key frames during decoding by providing the same matching mechanism at both a coding side and a decoding side. Thus, when coded data of the intermediate frame and the key frame data are acquired, original data can be restored at the decoding side. As described, the difference image can also be effectively compressed by, for example, using the Huffman coding or other coding methods. Further, it is to be noted that the frames may also be intra-frame compressed. Both the intermediate frames and key frames may be compressed by either a lossless or lossy method, and may be structured such that the compression method used can be designated thereto.

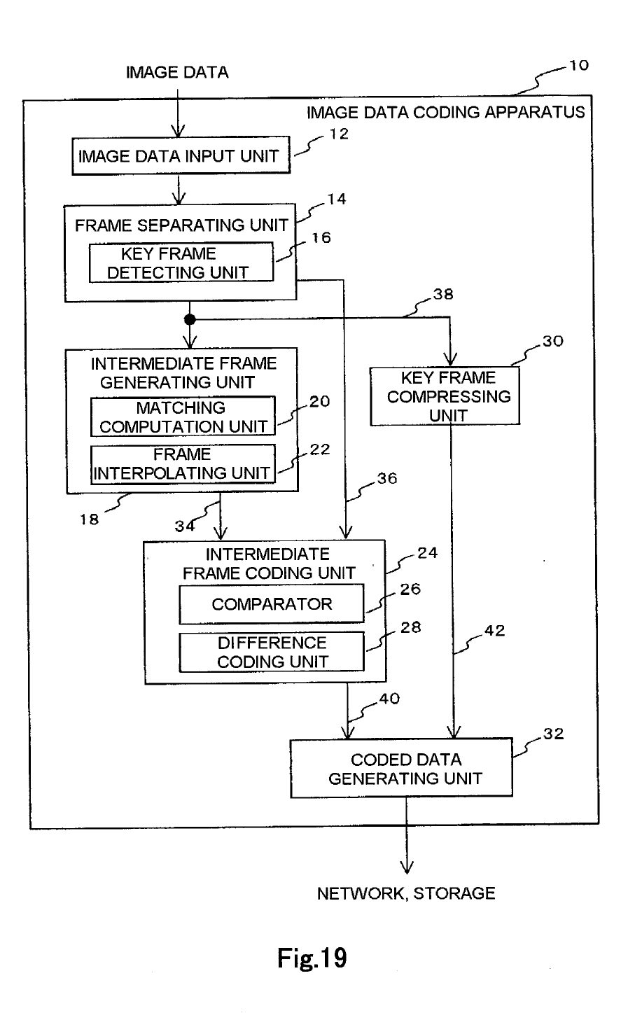

FIG. 19 shows a structure of an image data coding apparatus 10 which realizes the above-described coding processes. It will be understood that each functional unit in FIG. 19 can be realized by, for example, a program loaded from a recording medium such as CD-ROM in a PC (personal computer). A similar consideration applies to a decoding apparatus described later.

FIG. 20 is a flowchart showing processes carried out by the image data coding apparatus 10.

Referring to FIGS. 19 and 20, an image data input unit 12 receives image data to be coded from a network, storage or the like (S1010). Image data input unit 12 may be, for example, optical equipment having communication capability, storage controlling capability or which photographs or captures images.

A frame separating unit 14 separates frames included in the image data, into key frames and intermediate frames (S1012). In particular, a key frame detecting unit 16 may detect the key frames among a plurality of the frames, as those having an image difference from the immediately prior frame that is relatively large. Using this selection procedure, the differences among key frames does not become unmanageably large and coding efficiency improves. It is to be noted that the key frame detecting unit 16 may alternatively select a frame at constant intervals so as to select it as the key frame. In this case, the procedure becomes very simple. The separated key frames 38 are sent to an intermediate frame generating unit 18 and a key frame compressing unit 30. Frames other than the key frames, that is, the actual intermediate frames 36, are sent to an intermediate frame coding unit 24.

The key frame compressing unit 30 compresses the key frames, and outputs the compressed key frames to a coded data generating unit 32. A matching computation unit 20 in the intermediate frame generating unit 18 computes the matching between the key frames by utilizing the base technology or other available technique (S1014), and a frame interpolating unit 22 in the intermediate frame generating unit 18 generates a virtual intermediate frame 34 based on the computed matching (S1016). The virtual intermediate frame 34 thus generated is supplied to the intermediate frame coding unit 24.

A comparator 26 in the intermediate frame coding unit 24 determines a difference between a virtual intermediate frame 34 and an actual intermediate frame 36, and then a difference coding unit 28 codes this difference so as to produce coded data 40 of the intermediate frame (S1018). The coded data 40 of the intermediate frame are sent to the coded data generating unit 32. The coded data generating unit 32 generates and outputs final coded image data by combining the coded data 40 of the intermediate frame and the compressed key frames 42 (S1020).

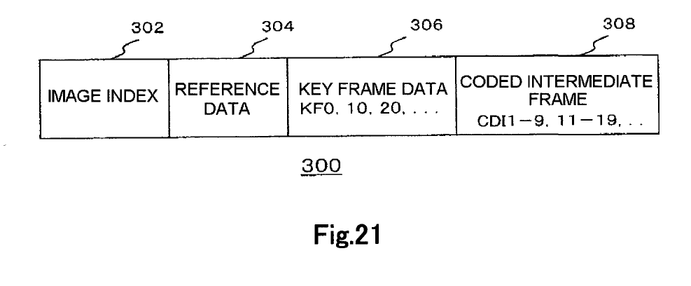

FIG. 21 shows an example of the structure of coded image data 300. The coded image data 300 includes (1) an image index region 302 which stores an index such as a title and ID of the image data for identifying the image data, (2) a reference data region 304 which stores data used in a decoding processing, (3) a key frame data storing region 306 and (4) a coded data storing region 308 for the intermediate frames, and are so structured that all (1) to (4) are integrated. As the reference data region 304, there are various parameters such as a coding method and a compression rate or the like. In FIG. 21, the key frame data storing region 306 includes KF 0, KF 10, KF 20, . . . as examples of the key frames, and the coded data storing region 308 includes CDI's (Coded Difference Images) 1-9 and 11-19 as examples of the coded data of the intermediate frames.

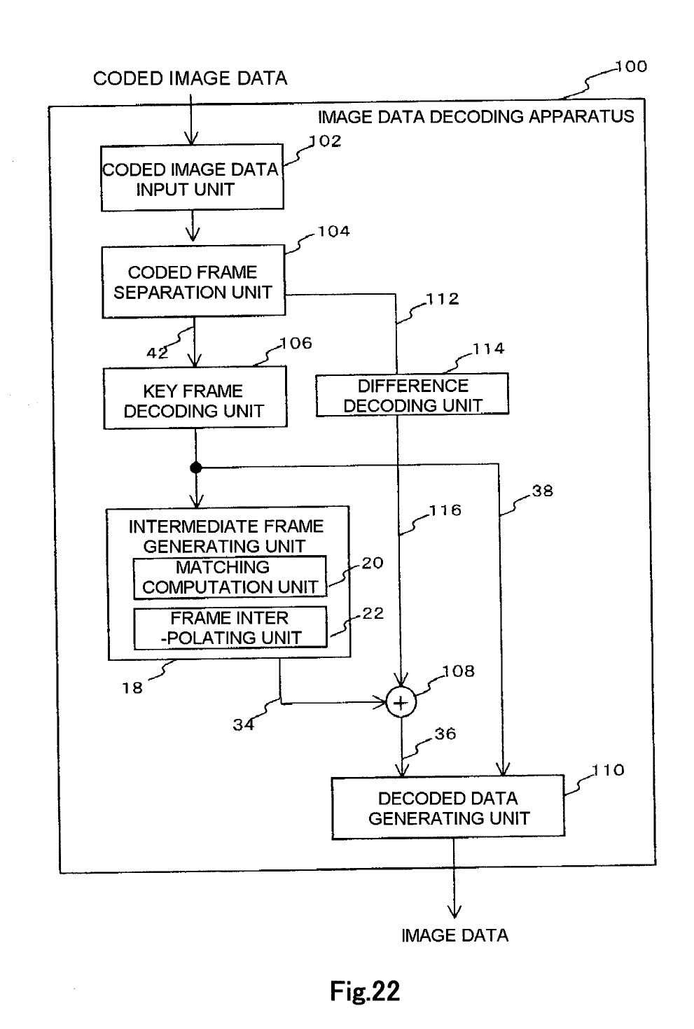

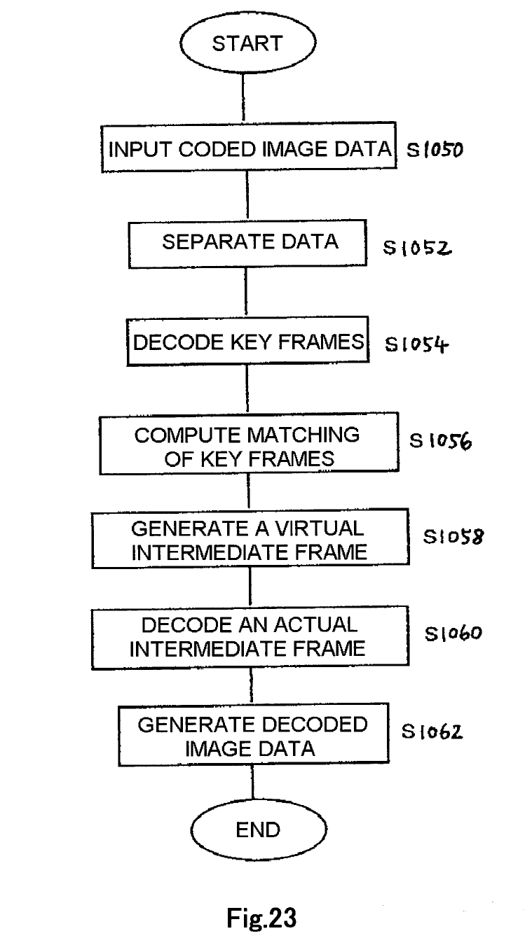

On the decoding side, FIG. 22 shows a structure of an image data decoding apparatus 100. FIG. 23 is a flowchart showing processes carried out by the image data decoding apparatus 100. The image data decoding apparatus 100 decodes the coded image data from the image data coding apparatus 10 to obtain the original image data.

In the image data decoding apparatus 100, a coded image data input unit 102 first acquires or receives coded image data from a network, storage, and so forth (S1050). A coded frame separating unit 104 separates compressed key frames 42 included in the encoded image data, from other supplementary data 112 (S1052). The supplementary data 112 includes coded data of the intermediate frames. The compressed key frames 42 are sent to a key frame decoding unit 106 and are decoded there (S1054). On the other hand, the supplementary data 112 are sent to a difference decoding unit 114, and difference images decoded by the difference decoding unit 114 are sent to an adder 108.

Key frames 88 output from the key frame decoding unit 106 are sent to a decoded data generating unit 110 and an intermediate frame generating unit 18. The intermediate frame generating unit 18 performs the same matching processing as in the coding process (S1056) and generates virtual intermediate frames 34 (S1058). The virtual intermediate frames 34 are sent to the adder 108, so that the virtual intermediate frames 34 are summed with the decoded difference images 116. As a result of the summation, actual intermediate frames 36 are decoded (S1060) and are then sent to the decoded data generating unit 110. The decoded data generating unit 110 decodes image data by combining the actual intermediate frames 36 and the key frames 38 (S1062).

By implementing the above image coding and decoding schemes, virtual intermediate frames are produced using pixel-by-pixel matching, so that a relatively high compression rate is achieved while also maintaining image quality. In an actual initial experiment, a higher compression rate was achieved at the same level of subjective image quality compared to a case where all frames are uniformly compressed by JPEG.

As a modification of the above embodiments, an error control method may be introduced. This method suppresses the error between the coded image data and the original image data within a predetermined range. The error may be evaluated by using an evaluation equation such as the sum of squares of intensity values of the corresponding pixels in two images in terms of their positions. Based on this error, the coding method-and compression rate of the intermediate frame and key frame can be adjusted, or the key frames can be re-selected. For example, when the error relating to a certain intermediate frame exceeds an allowable value, a new key frame can be provided in the vicinity of the intermediate frame or the interval between two key frames which have the intermediate frame there between can be made smaller.

As another modification, the image data coding apparatus 10 and the image data decoding apparatus 100 may be structured integrally. In this case, the intermediate frame generating unit 18 may be shared and may serve as a central unit. The integrated image coding-decoding apparatus codes the images and stores them in a storage, and decodes them, when necessary, so as to be displayed and so forth.

As still another modification, the image data coding apparatus 10 may be structured such that the virtual intermediate frames are input after being generated outside the apparatus 10. In this case, the image data coding apparatus 10 can be structured as including only the intermediate frame coding unit 24, coded data generating unit 32 shown in FIG. 19 and/or the key frame compressing unit 30 (if necessary). Still other modified examples may further include other cases depending on how other functional unit/units is/are freely provided outside the apparatus 10 as will be understood to those skilled in the art.

Similarly, the image data decoding apparatus 100 may be structured such that the key frame, virtual intermediate frame and coded data of the intermediate frame are input after being generated outside the apparatus 100. In this case, the image data decoding apparatus 100 can be structured as including only the difference decoding unit 114, adder 108 and decoded data generating unit 11O shown in FIG. 22. The same freedom in designing the structure of the image data decoding apparatus 100 exists as in the image data coding apparatus 10.

The above embodiments are described with an emphasis on pixel-by-pixel matching. However, the image data coding and decoding techniques according to the present embodiments are not limited thereto, and include obtaining the virtual intermediate frames through a process performed between the key frames as well as a technique as a whole that may include these processes as preprocessing. For example, a block matching may be computed between key frames. Moreover, linear or nonlinear processing may be carried out for generating the virtual intermediate frame. Similar considerations may be applied at the decoding side.

It is to be noted that one of key points in implementing the techniques above lies in obtaining the virtual intermediate frame by the same method is at both the coding side and decoding side as a general rule. However, this is not absolutely, necessary, and the decoding side may function following a rule adopted in the coding process, or the coding side may perform the coding while presupposing the processing at the decoding side.

Embodiments for Image Data Coding and Decoding Techniques

In the coding and decoding techniques according to the present invention (hereinafter referred to as “extended technology”), the above-described coding and decoding techniques for the intermediate frames are also applied to the key frames. In the Japanese Patent Application 2001-21098, the key frames are described as only being intra-frame compressed. However, in the extended technology, the key frames are compressed by being hierarchized such that key frames are classified into independent key frames which can be decoded without referring to other frames, and dependent key frames which are key frames other than the independent key frames.

The dependent key frames are coded by coding a difference between a virtual key frame, which is generated based on a matching between independent key frames, and an actual key frame. On the other hand, the intermediate frames are coded based on the matching between the actual key frames, that is, the intermediate frames are processed according to the technique described above and disclosed in Japanese Patent Application No. 2001-21098.

In the initial embodiments above, the same matching function is preferably implemented at both the coding and decoding sides. However, the following embodiments do not include this limitation. For example, in the following embodiments, a matching result computed at the coding side may be stored in a corresponding point file and this matching result may be handed over to the decoding side. In this case, a computational load at the decoding side (i.e. required for matching) can be reduced.

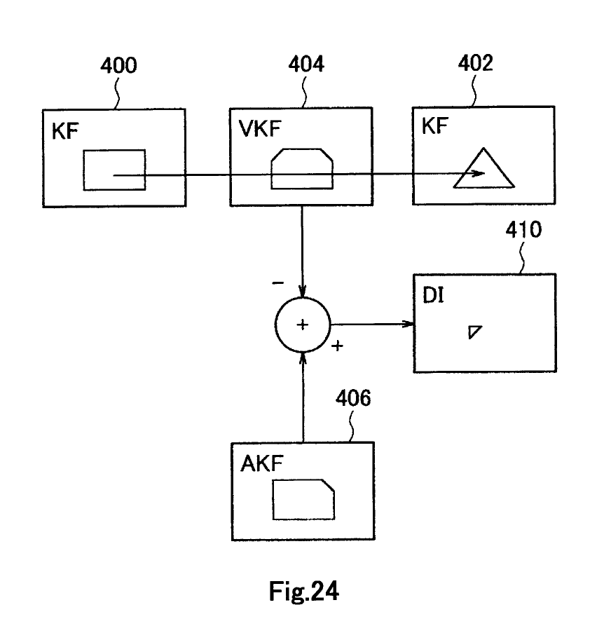

FIG. 24 is a conceptual diagram showing a process in which the image data are coded according to the extended technology. FIG. 24 differs from FIG. 18 in that this process is performed for key frames only. First, consider a group of key frames, a first key frame 400, a second key frame 402 and a third key frame 406. In this example, the third key frame 406 is between the first key frame 400 and the second key frame 402, and the first and second key frames 400 and 402 are defined as independent key frames whereas the third key frame 406 is defined as a dependent key frame. Now, a virtual third key frame VKF 404 may be generated based on a matching between the first and second key frames (KF 400 and KF 402). Next, a difference image DI 410 between this virtual third key frame VKF 404 and an actual key frame AKF 406 can be coded.

Thus, the coded image data may include the following data D1-D4:

D1: Independent key frame data.

D2: Coded data of dependent key frames.

D3: Coded data of intermediate frames.

D4: Corresponding point files between actual key frames.

It will be understood that data D1 may be compression-coded. Similarly, in the present patent specification, it will be understood that even if there is no explicit expression that data are compressed or coded, various compression or coding methods may be performed on the data in question. Data D2 are coded data of a difference image. Data D3 are generated based on actual key frames. Data D4. is optional as described above, however, it is to be noted that since data D4 can be used for decoding both independent key frames and intermediate frames, the extended technology may be advantageous in terms of efficiency.

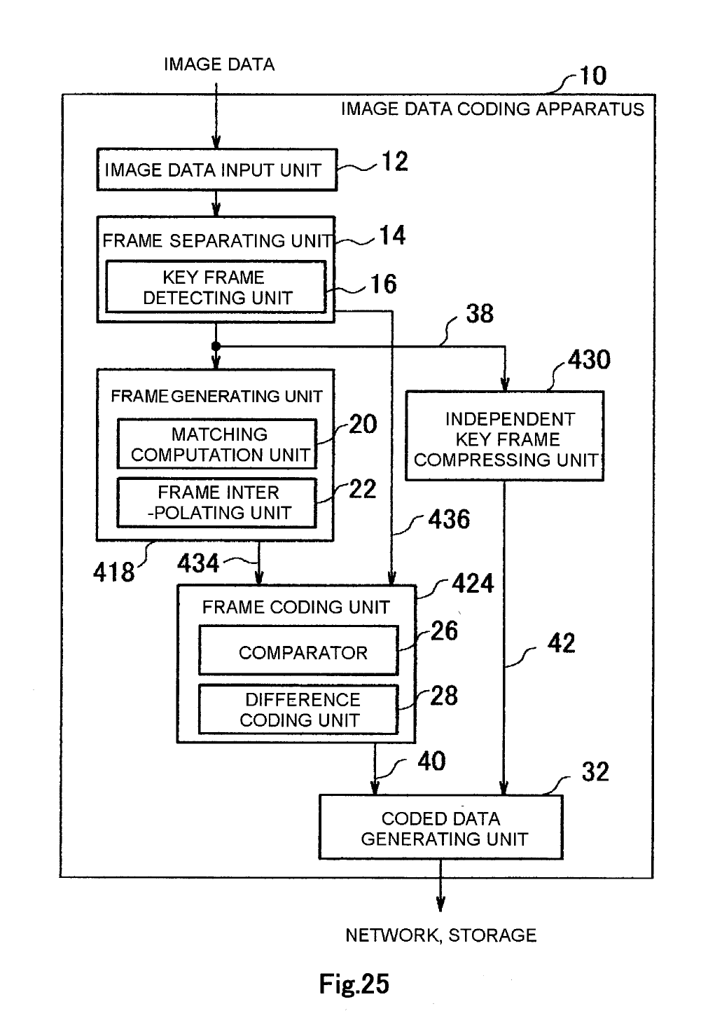

FIG. 25 shows an image data coding apparatus 10 according to an embodiment of the invention. FIG. 25 differs from FIG. 19, first, in that the intermediate frame generating unit 18 is replaced with a frame generating unit 418. In the frame generating unit 418, both intermediate frames and virtual key frames are generated in order to code dependent key frames. The virtual key frames and the intermediate frames 434 are sent to a frame coding unit 424. In the frame coding unit 424, both intermediate frames and dependent key frames are coded. Thus, actual intermediate frames and actual key frames 436 are input to the frame coding unit 424. An independent key frame compressing unit 430 intra-frame compresses and codes independent key frames only, from among the key frames.

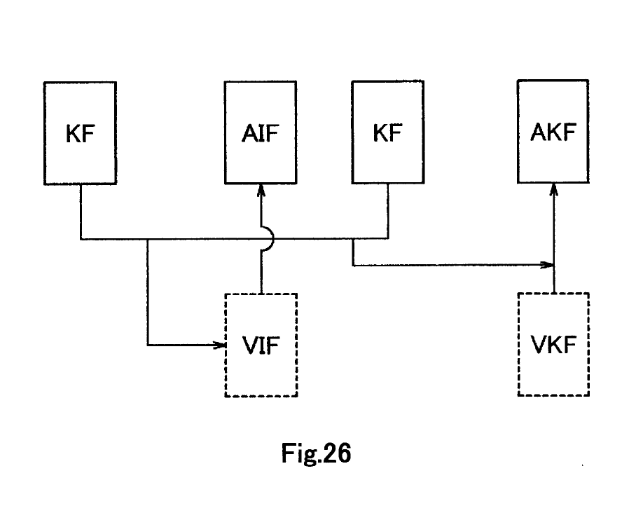

FIG. 26 schematically illustrates a procedure,in which both dependent key frames and intermediate frames are coded by utilizing the actual key frames. In FIG. 26, “KF” and “AKF” are both actual key frames with “KF” representing independent key frames and “AKF” representing a dependent key frame, “AIF” and “VIF” are an actual intermediate frame and a virtual intermediate frame, respectively, and “VKF” is a virtual key frame. Referring to FIG. 26, the virtual key frame VKF is generated from the actual key frames KF, and then the dependent key frame AKF is coded based on the thus generated virtual key frame VKF. On the other hand, the virtual intermediate frame VIF is also generated from the two key frames KF's, and the actual intermediate frame AIF is coded based on the thus generated virtual intermediate frame VIF. In other words, a single matching between the key frames provides coding of another key frame and an intermediate frame.

It is to be noted that, as for the dependent frame AKF, either interpolation or extrapolation may be utilized based on the two independent key frames KF. In general, extrapolation is used when key-frames come in the sequence of, for example, an independent frame, an independent frame and a dependent frame whereas interpolation is used when the key frames come in the order of, for example, an independent frame, a dependent frame and an independent frame.

In FIG. 26, only one dependent key frame AKF is shown being coded-from the two independent key frames KF's. However, using a similar approach most of the key frames can be actually coded as dependent key frames by repeating the matching on two adjacent key frames. In particular, if difference images are coded using a lossless method, the dependent key frames may be completely restored to the original key frames. Thus, certain dependent key frames can be used to code other dependent key frames. In this connection, it is noted that the coded image data design may be such that dependence of key frames is closed for predetermined intervals to provide a concept similar to the GOP system which serves as a unit for random access in the case of MPEG. In any case, the extended technology is advantageous in that the key frames can also be coded with high compressibility. The extended technology is further advantageous because the matching accuracy is high in the base technology and similarity of images between key frames is relatively high.

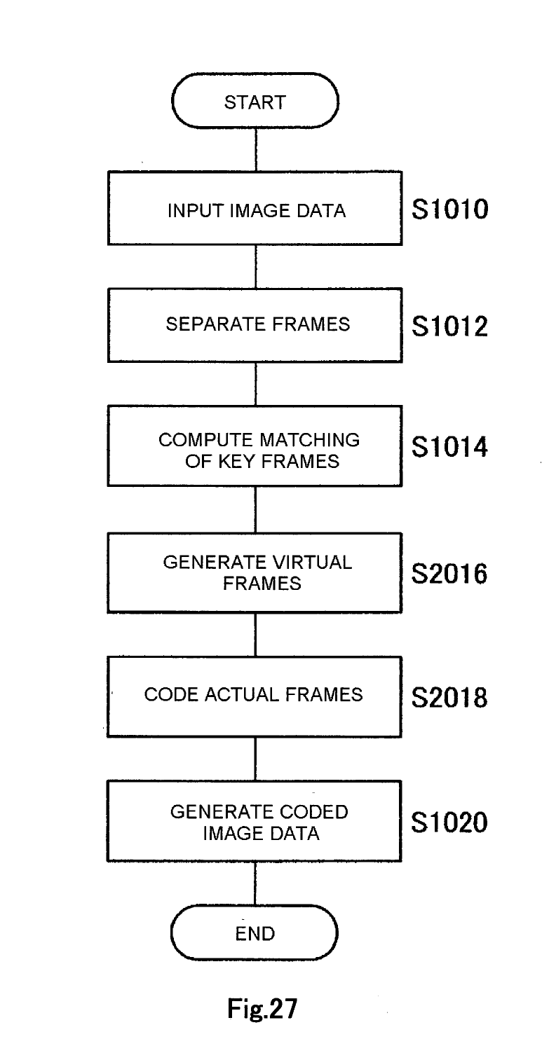

FIG. 27 is a flowchart showing processes carried out by the image data coding apparatus 10. FIG. 27 differs from FIG. 20 in that both the virtual key frame and virtual intermediate frame are generated (S2016) after the matching of key frames has been computed (S1014). Thereafter, the actual frames are coded using the virtual frames (S2018), and a stream of final coded image data is generated and output (S1020).

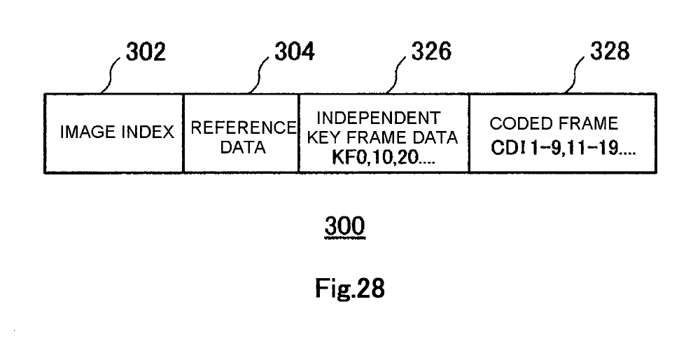

FIG. 28 is an example structure of coded image data 300. FIG. 28 differs from FIG. 21 in that there is an independent key frame data region 326 in place of the key frame data region 306 and there is a coded frame region 328, which includes coded data for key frames, in place of the coded intermediate frame region 308.

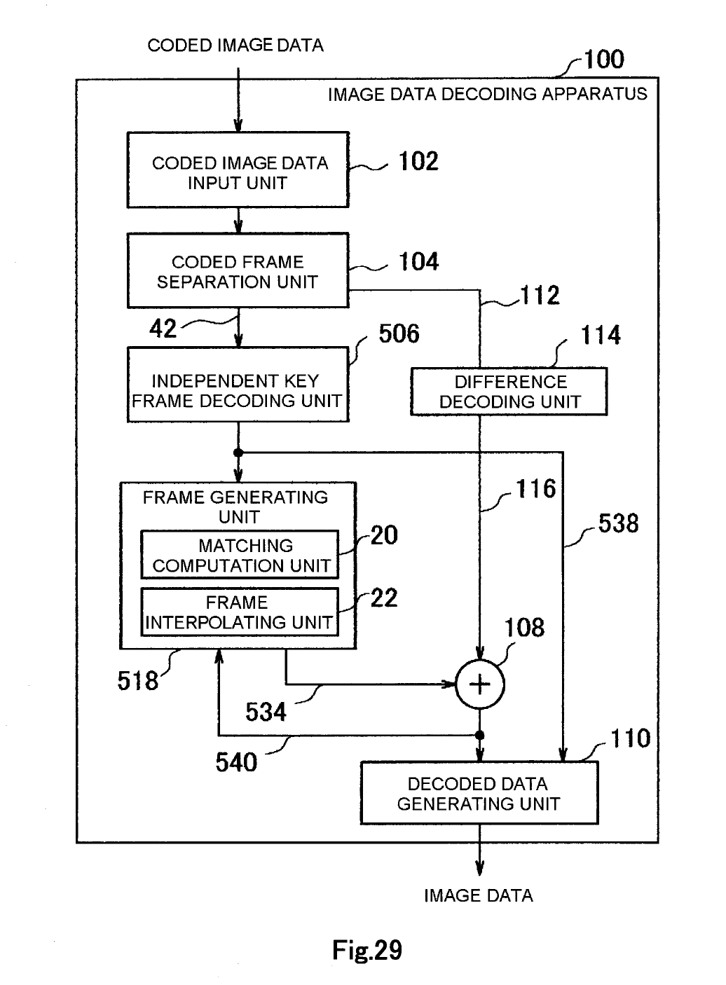

On the decoding side, FIG. 29 shows a structure of an image data decoding apparatus 100. FIG. 29 differs from FIG. 22 in that the key frame decoding unit 106 is replaced by an independent key frame decoding unit 506 which reproduces the independent key frames by the intra-frame decoding method. Next, an independent key frame 538 is input to a frame generating unit 518 and a virtual dependent key frame is first generated. Data 534 of this virtual dependent key frame is summed with the difference image 116 decoded by the difference decoding unit 114, so that an actual dependent key frame is decoded.

The actual dependent key frame 540 is fed back to the frame generating unit 518, until required actual key frames are available. Thereafter, the intermediate frame is decoded through a similar process to that shown in FIG. 29, so that all actual frames can be regenerated.

Though in this example the image data decoding apparatus 100 itself also performs the matching process, the data decoding apparatus may be structured such that corresponding point files between-key frames are acquired from the coding side. In that case, the matching computation unit 20 will not be necessary in the image data decoding apparatus 100. Though the corresponding point files may be embedded in any place within a stream of the coded image data, in this embodiment it is, for example, embedded as part of coded data of the dependent key frame.

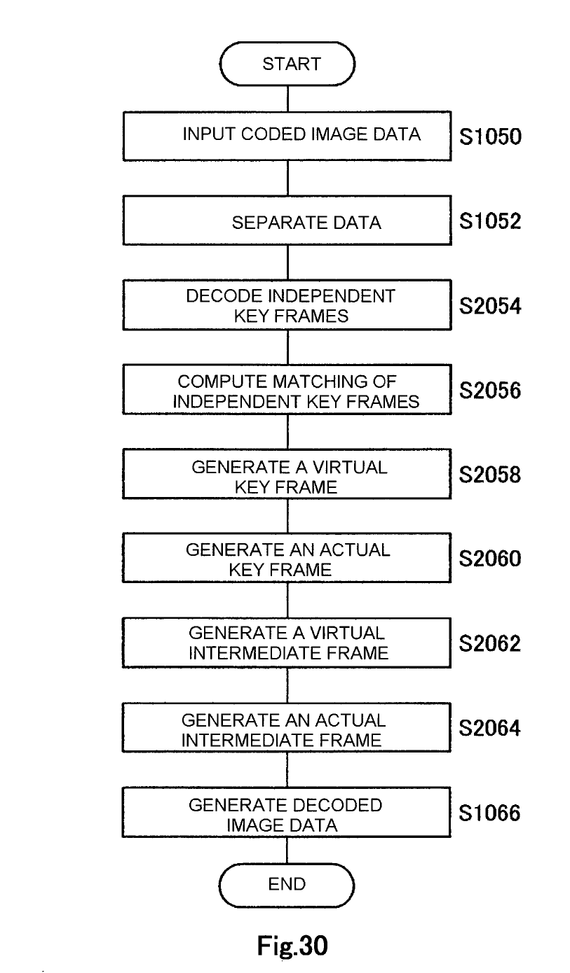

FIG. 30 is a flowchart showing processes carried out by the image data decoding apparatus 100. FIG. 30 differs from FIG. 23 in that the independent key frames are first decoded (S2054) and the matching is computed therebetween (S2056) in the extended technology. Thereafter, a virtual key frame is generated (S2058). The thus generated virtual key frame is combined with a difference image, so that an actual key frame is decoded (S2060). Next, the key frames are used in an appropriate sequence to generate virtual intermediate frames (S2062). A thus generated virtual intermediate frame is combined with a difference image, so that an actual intermediate frame is decoded (S2064).

The above embodiments illustrate coding and decoding of key frames and intermediate frames using the extended technology. However, it is noted that there may also be various modifications and variations to the extended technology. For example, the base technology may or may not be used as the matching computation in the extended technology.

Next, other modified examples of the present embodiments will be described.

Modifications

In the description relating to FIG. 24 above, the third key frame was considered as a dependent frame while the first key frame and the second key frame were regarded as independent key frames, and a difference between a virtual third key frame and an actual third key frame were coded. However, as an alternative coding method, it is possible to regard only the first key frame as an independent key frame. In this case, the process involves: (1) computing a matching between the first key frame and the second key frame, (2) generating a virtual second key frame based on a result of (1) and the first key frame, and (3) coding an actual second key frame by utilizing the virtual second key frame. Namely, the second key frame may also be regarded as a dependent key frame and be coded based on correspondence information (corresponding point file) between the second key frame itself and the first key frame. Specifically, each pixel of the first key frame may be moved according to information on the corresponding points, so as to generate the virtual second key frame. Next, the difference between this virtual second key frame and the actual second key frame may be entropy-coded and then compressed.

By implementing this method, after the information on the corresponding points is determined, it is not necessary to refer to the second key frame data. The virtual second key frame is generated by moving each pixel of the first key frame according to the information on the corresponding points. At this stage, color of pixels may not be reflected among data for the second key frame. However, the color of pixels may be reflected at the above-described stage of determining the difference data. It will be understood that the difference data may be coded by either q lossless or lossy method. The coded data stream may be generated by combining and effecting the first key frame, the coded second key frame and information on the corresponding points, and is then output.

When considering this modified method in terms of the image data coding apparatus 10 shown in FIG. 25, the frame generating unit 418 generates a virtual key frame which relates to the second key frame. The frame coding unit 424 codes a difference between the virtual second key frame and the actual second key frame. The independent key frame compressing unit 430 intra-frame compresses and codes the first key frame only.

A decoding method that corresponds to the above-described coding is also possible. Namely, this decoding method includes: (1) acquiring a coded data stream which stores-data of the first key frame and data of the second key frame which is coded based on information on corresponding points between the first and second key frames; (2) decoding the second key frame from the thus acquired coded data stream; and (3) generating an intermediate frame between the first key frame and the second key frame, by utilizing the first key frame, decoded second key frame and corresponding point data.

When considering this decoding method in terms of the image data decoding apparatus 100 shown in FIG. 29, the first key frame is reproduced at the independent key frame decoding unit 506 by the intra-frame decoding method. The independent key frame 538 is input to the frame generating unit 518, so that the virtual second key frame is generated first. This data 534 is summed with the difference image 116, which has been decoded by the difference decoding unit 114, so that the actual second key frame is decoded.

This actual second key frame 540 is fed back to the frame generating unit 518. Thereafter, the intermediate frame or frames between the first key frame and the second key frame can be decoded, and thus all frames are prepared.

It is to be noted that difference data on color between corresponding pixels of the first key frame and the second key frame may also be incorporated into the corresponding point data. In this case, color of the second key frame can also be considered at the time of generating the virtual second key frame. Whether the color is to be considered at such an early stage or it is to be added at a later stage (i.e. when considering difference data) may be selectable.

Although the present invention has been described by way of exemplary embodiments, it should be understood that many changes and substitutions may be made by those skilled in the art without departing from the scope of the present invention which is defined by the appended claims.

What is claimed is:

1. A method of coding image data, comprising:
computing a primary matching between a first key frame and a second key frame included in the image data;
generating a virtual third key frame based on a result of the primary matching;
coding an actual third key frame included in the image data, by utilizing the virtual third key frame; and
computing a secondary matching between adjacent key frames among the first, second and actual third key frames.

2. A method according to claim 1, wherein said computing a primary matching includes computing, pixel by pixel, a matching between the first key frame and the second key frame, and said generating includes generating the virtual third key frame by performing, pixel by pixel, an interpolation computation based on a correspondence relation of position and intensity of pixels between the first and second key frames.

3. A method according to claim 1, further comprising:
outputting, as a coded data stream, the first and second key frames, the coded third key frame and corresponding point data obtained as a result of said secondary matching.

4. A method according to claim 3, wherein the coded third key frame is generated in such a manner that the coded third key frame includes difference data related to a difference between the virtual third key frame and the actual third key frame.

5. A method according to claim 4, wherein the coded third key frame is generated in such a manner that the coded third key frame further includes corresponding point data obtained as a result of said primary matching.

6. A method of coding image data in which image frame data are separated into a key frame and an intermediate frame so as to be coded, the method characterized in that the intermediate frame is coded based on a result of matching between key frames, and at least one of the key frames is also coded based on a result of matching between other key frames.

7. An image data coding apparatus, comprising:
a unit which acquires image data that includes a plurality of frames;
a unit which computes a primary matching between first and second key frames included in the acquired image data;
a unit which generates a virtual third key frame based on a result of the primary matching;
a unit which codes an actual third key frame by utilizing the virtual third key frame; and
a unit which computes a secondary matching between adjacent key frames among the first, second and actual third key frames.

8. An image data coding apparatus according to claim 7, wherein the first, second and third key frames are arranged in this temporal order, and said generating unit generates the virtual third key frame by extrapolation.

9. An image data coding apparatus according to claim 7, wherein the first, third and second key frames are arranged in this temporal order, and said generating unit generates the virtual third key frame by interpolation.

10. An image data coding apparatus according to claim 7, wherein said coding unit codes a difference between the virtual third key frame and the actual third key frame.

11. An image data coding apparatus according to claim 7, wherein said secondary-matching computing unit computes a pixel-by-pixel matching between the adjacent key frames.

12. An image data coding apparatus according to claim 7, wherein said generating unit computes a pixel-by-pixel matching between the first and second key frames, and generates the virtual third key frame by performing an interpolation computation based on a result thereof.

13. An image data coding apparatus according to claim 7, further comprising:
a unit which outputs the first and second key frames, the coded third key frame and data obtained as a result of the secondary matching as a coded data stream.

14. An image data coding apparatus according to claim 7, wherein the coded third key frame is generated in such a manner that the coded third key frame includes difference data related to a difference between the virtual third key frame and the actual third key frame.

15. An image data coding apparatus according to claim 7, wherein the coded third key frame is generated in such a manner that the coded third key frame further includes corresponding point data obtained as a result of the primary matching.

16. An image data coding apparatus according to claim 13, wherein the coded data stream stores a result of the secondary matching as corresponding point data.

17. An image data coding apparatus according to claim 7, wherein said coding unit further codes an actual intermediate frame by utilizing a virtual intermediate frame generated based on a result of the secondary matching.

18. An image data coding apparatus according to claim 17, wherein said coding unit codes a difference between the virtual intermediate frame and the actual intermediate frame.

19. A computer program executable by a computer, the program comprising the functions of:
computing a primary matching between a first key frame and a second key frame included in the image data;
generating a virtual third key frame based on a result of the primary matching;
coding an actual third key frame included in the image data, by utilizing the virtual third key frame; and
computing a secondary matching between adjacent key frames among the first, second and actual third key frames.

20. A computer program, executable by a computer, for coding image data in which image frame data are separated into a key frame and an intermediate frame so as to be coded, the program including the functions of:
coding the intermediate frame based on a result of matching between key frames, and also coding at least one of the key frames based on a result of matching between other key frames.

21. An image decoding method, comprising:
acquiring a coded data stream which includes data of first and second key frames and data of a third key frame coded based on a result of a matching between the first and second key frames;
decoding the third key frame from the acquired coded data stream; and
computing a matching between adjacent key frames among the first, second and third key frames, and thereby generating an intermediate frame.

22. An image decoding method, comprising:
acquiring a coded data stream which includes data of first and second key frames, data of a third key frame coded based on a result of a matching therebetween, and corresponding point data obtained as a result of computation of a matching between adjacent key frames among the first, second and third key frames;
decoding the third key frame from the acquired coded data stream; and
generating an intermediate frame based on the corresponding point data.

23. A method according to claim 21, wherein the coded third key frame data includes coded data of a difference between a virtual third key frame generated based on a matching computed between the first and second key frames and an actual third key frame.

24. A method according to claim 23, wherein, in said decoding, after the virtual third key frame is generated by computing the matching between the first and second key frames, the actual third key frame is decoded based on the thus generated virtual third key frame.

25. A method according to claim 21, wherein the coded third key frame data includes corresponding point data which is a result of the matching computed between the first and second key frames and coded data of a difference between a virtual third key frame to be generated based on the corresponding point data and an actual third key frame.

26. A method according to claim 25, wherein, in said decoding, after the virtual third key frame is generated based on the corresponding point data, the actual third key frame is decoded based on the thus generated virtual third key frame.

27. An image decoding apparatus, comprising:
a unit which acquires a coded data stream that includes data of first and second key frames and data of a third key frame coded based on a result of a matching between the first and second key frames;
a unit which decodes the third key frame from the acquired coded data stream; and
a unit which computes a matching between adjacent key frames among the first, second and third key frames, and thereby generates an intermediate frame.

28. An image decoding apparatus, comprising:
a unit which acquires a coded data stream that includes data of first and second key frames, data of a third key frame coded based on a result of a matching therebetween, and corresponding point data obtained as a result of computation of a matching between adjacent key frames among the first, second and third key frames;
a unit which decodes the third key frame from the acquired coded data stream; and
a unit which generates an intermediate frame based on the corresponding point data.

29. An image decoding apparatus according to claim 28, wherein the coded third key frame data includes coded data of a difference between a virtual third key frame generated based on a matching computed between the first and second key frames, and an actual third key frame.

30. An image decoding apparatus according to claim 29, wherein after the virtual third key frame is generated by computing the matching between the first and second key frames, said decoding unit decodes the actual third key frame based on the virtual third key frame.

31. An image decoding apparatus according to claim 28, wherein the coded third key frame data includes corresponding point data which is a result of the matching computed between the first and second key frames and coded data of a difference between a virtual third key frame to be generated based on the corresponding point data and an actual third key frame.

32. An image decoding apparatus according to claim 31, wherein after the virtual third key frame is generated based on the corresponding point data, said decoding unit decodes the actual third key frame based on the virtual third key frame.

33. A method of coding image data, comprising:
separating frames included in the image data into key frames and intermediate frames;
generating a series of source hierarchical images of different resolutions by operating a multiresolutional critical point filter on a first key frame obtained by said separating;
generating a series of destination hierarchical images of different resolutions by operating the multiresolutional critical point filter on a second key frame obtained by said separating;
computing a matching of the source hierarchical images and the destination hierarchical images in a resolutional level hierarchy;
generating a virtual third key frame based on a result of the matching; and
coding an actual third key frame included in the image data, by utilizing the virtual third key frame.

34. An image data coding apparatus, comprising:
a first functional block which acquires a virtual key frame generated based on a result of a matching performed between key frames included in image data; and
a second functional block which codes an actual key frame included in the image data, by utilizing the virtual key frame.

35. An image data coding apparatus according to claim 34, further comprising:
a third functional block which computes a matching between adjacent key frames including the actual key frame and which codes an intermediate frame that is other than the key frames.

36. An image decoding method, comprising:
acquiring, from a coded data stream of image data, first and second key frames and a third key frame which is coded based on a result of a processing performed between the first and second key frames and which is different from the first and second key frames;
decoding the thus acquired coded third key frame; and
generating an intermediate frame, which is not a key frame, by performing a processing between a plurality of key frames including the third key frame obtained as a result of said decoding.

37. An image decoding apparatus, comprising:
a first functional block which acquires, from a coded data stream of image data, first and second key frames and a third key frame which is coded based on a result of a processing performed between the first and second key frames and which is different from the first and second key frames;
a second functional block which decodes the thus acquired coded third key frame; and
a third functional block which generates an intermediate frame, which is not a key frame, by performing a processing between a plurality of key frames including the third key frame obtained in said second functional block.

38. A computer program executable by a computer, the program comprising the functions of:
acquiring a coded data stream that includes data of first and second key frames and data of a third key frame coded based on a result of a matching between the first and second key frames;
decoding the third key frame from the acquired coded data stream; and
computing a matching between adjacent key frames among the first, second and third key frames, and thereby generating an intermediate frame.

39. A computer program executable by a computer, the program comprising the functions of:
acquiring a coded data stream that includes data of first and second key frames, data of a third key frame coded based on a result of a matching therebetween, and corresponding point data obtained as a result of computation of a matching between adjacent key frames among the first, second and third key frames;
decoding the third key frame from the acquired coded data stream; and
generating an intermediate frame based on the corresponding point data.

40. A method of coding image data, comprising:
computing a matching between first and second key frames included in the image data;
generating a virtual second key frame based on a result of the matching and the first key frame; and
coding an actual second key frame by utilizing the virtual second key frame.

41. A method according to claim 40, wherein said coding includes compressing a difference between the actual second key frame and the virtual second key frame.

42. A method according to claim 40, further comprising:
incorporating the first key frame, coded second key frame and corresponding point data obtained as a result of the matching into a coded data stream, so as to be output.

43. An image data coding apparatus, comprising:
a unit which acquires image data including a plurality of frames;
a matching unit which computes a matching between first and second key frames included in the acquired image data;
a generating unit which generates a virtual second key frame based on a result of the matching and the first key frame; and
a coding unit which codes an actual second key frame by utilizing the virtual second key frame.

44. A computer program executable by a computer, the program comprising the functions of:
computing a matching between first and second key frames included in image data;
generating a virtual second key frame based on a result of the matching and the first key frame; and
coding an actual second key frame by utilizing the virtual second key frame.

45. An image decoding method, comprising:
acquiring a coded data stream that includes data of a first key frame and a second key frame which is coded based on a result of a matching between the first and second key frames;
decoding the second key frame from the acquired coded data stream; and
generating an intermediate frame between the first key frame and the second key frame by utilizing the first key frame, decoded second key frame and a result of the matching therebetween.

46. An image decoding apparatus, comprising:
a unit which acquires a coded data stream that includes data of a first key frame and a second key frame which is coded based on a result of a matching between the first and second key frames;
a unit which decodes the second key frame from the coded data stream acquired by said acquiring unit; and
a unit which generates an intermediate frame between the first key frame and the second key frame by utilizing the first key frame, decoded second key frame and a result of the matching therebetween.

47. A computer program executable by a computer, the program comprising the functions of:
acquiring a coded data stream that includes data of a first key frame and a second key frame which is coded based on a result of a matching between the first and second key frames;
decoding the second key frame from the acquired coded data stream; and
generating an intermediate frame between the first key frame and the second key frame by utilizing the first key frame, decoded second key frame and a result of the matching therebetween.

48. A coded image data structure, comprising:
an index region which identifies image data;
a reference data region which includes data used in a decoding processing;
an independent frame data region which includes data relating to independent frames which are decoded independent of other frames; and
a coded frame region which includes data related to dependent frames which are decoded depending on other frames,
wherein said regions are integrated to form the coded image data.

49. A coded image data structure according to claim 48, wherein said coded frame region includes coded data of a difference between an actual dependent frame and a virtual dependent frame determined based on data related to an independent frame.
